(19) United States
(12) Patent Application Publication
(10) Pub. No.: US 2026/0327046 A1
(43) Pub. Date: Oct. 22, 2026

(54) Crane Apparatus

(71) Applicant: Tadano Ltd., Takamatsu-shi, Kagawa, (JP)

(72) Inventors: Keita MASHIMA, Takamatsu-shi, Kagawa (JP); Hiroyuki HAYASHI, Takamatsu-shi, Kagawa (JP)

(21) Appl. No.: 19/491,033

(22) PCT Filed: Jun. 19, 2024
(86) PCT No.: PCT/JP2024/022178

§ 371 Date: Dec. 8, 2025

(30) Foreign Application Priority Data
Jun. 19, 2023 (JP) JP 2023-100294

(51) Int. Cl. B66C 13/46; B66C 13/44; B66C 13/54; B66C 23/88

(52) U.S. Cl. CPC B66C 13/46; B66C 13/44; B66C 13/54; B66C 23/88

(57) ABSTRACT

A crane apparatus generates a wide-range overhead view image at a low cost, and includes sensors, wide-angle cameras, a display, a slewing base, a boom, and a winch. One wide-angle camera is attached to a lower surface of the boom in a lie-down posture. Another wide-angle camera is attached to an upper surface of the boom in the lie-down posture. Angles of view of the wide-angle cameras are both 210 degrees. One wide-angle camera captures a front side of the crane vehicle from above. Another wide-angle camera captures a rear side of the crane vehicle from above. The wide-angle cameras capture entire surroundings of the crane vehicle from above. Overhead view image data is generated based on image data generated by the wide-angle cameras. An overhead view image indicated by the overhead view image data is displayed.

### TECHNICAL FIELD

The present invention relates to a crane apparatus including a slewing base and a boom.

### BACKGROUND ART

Patent Document 1 discloses a crane apparatus including a slewing base and a boom. Four peripheral cameras each facing front, rear, left, and right are provided to the slewing base. The four peripheral cameras have wide-angle lenses, and capture entire surroundings of the crane apparatus. Four images captured by the four peripheral cameras are synthesized to generate an overhead view image.

### PRIOR ART DOCUMENT

### Patent Document

[Patent Document 1] Japanese Laid-Open Patent Publication No. 2011-151742

### SUMMARY OF THE INVENTION

### Problems to be Solved by the Invention

The peripheral cameras described in Patent Document 1 are provided to the slewing base. Therefore, the generated overhead view image takes a height of the slewing base as a reference. However, since a crane apparatus has a wide working range (working radius), there is a risk that the overhead view image which can cover all of the working range cannot be obtained by the crane apparatus described in Patent Document 1.

Furthermore, the crane apparatus described in Patent Document 1 requires the four peripheral cameras in order to generate the overhead view image, which increases a cost.

The present invention has been made considering the above-described circumstances, and an object thereof is to provide a crane apparatus that can generate a wide-range overhead view image at a low cost.

### Means for Solving the Problems

(1) A crane apparatus according to the present invention includes a slewing base, a boom provided to the slewing base so as to be able to stand and lie, the boom being able to extend and retract, a first wide-angle camera attached to a first side surface of the boom, a second wide-angle camera attached to a second side surface on an opposite side of the first side surface, and a controller configured to execute correction processing of correcting first captured image data generated by the first wide-angle camera and second captured image data generated by the second wide-angle camera, and overhead view image generating processing of generating overhead view image data indicating an overhead view image, based on corrected first captured image data and corrected second captured image data.

The first wide-angle camera and the second wide-angle camera are arranged facing opposite directions to each other with interposing the boom. The first wide-angle camera captures surroundings of a front portion of the crane apparatus, and the second wide-angle camera captures surroundings of a rear portion of the crane apparatus. Or, the first wide-angle camera captures surroundings of a left portion of the crane apparatus, and the second wide-angle camera captures surroundings of a right portion of the crane apparatus. In other words, the first wide-angle camera and the second wide-angle camera capture a range of surroundings of the crane apparatus, the range being wider than that in a case where the cameras are attached to the slewing base. The overhead view image data indicating the overhead view image is generated based on the first captured image data and the second captured image data generated by the first wide-angle camera and the second wide-angle camera. As a result, the crane apparatus according to the present invention can generate the overhead view image data indicating a wide-range overhead view image by the two wide-angle cameras. In other words, the crane apparatus according to the present invention can generate the wide-range overhead view image at a low cost.
(2) The boom may have a plurality of tube bodies including a base boom, and the first wide-angle camera and the second wide-angle camera may be provided to the base boom.

Since the first wide-angle camera and the second wide-angle camera are provided to the base boom, wiring of cables becomes easier compared to a case where the first wide-angle camera and the second wide-angle camera are attached to another tube body that slides relative to the base boom. Furthermore, height positions of the first wide-angle camera and the second wide-angle camera are not changed by an extension or a retraction of the boom. Since the height positions of the first wide-angle camera and the second wide-angle camera are not changed, a change in a height position of a viewpoint of the overhead view image by the extension or the retraction of the boom can be suppressed.
(3) The first side surface may be a lower surface of the boom in a lie-down posture in which the boom extends along a horizontal direction, and the second side surface may be an upper surface of the boom in the lie-down posture.

If the first wide-angle camera and the second wide-angle camera were respectively provided to left and right side surfaces of the boom in the lie-down posture, there would be a risk that a suspended-load hook suspended from a tip end of the boom and a suspended load attached to the suspended-load hook extend across both a captured image captured by the first wide-angle camera and a captured image captured by the second wide-angle camera. If the suspended-load hook and the suspended load extended across the two images, there would be a risk that an operator may feel uncomfortable about images of the suspended-load hook and the suspended load in the overhead view image generated by synthesizing the two images. By attaching the first wide-angle camera to the lower surface (first side surface) of the boom in the lie-down posture, the suspended-load hook and the suspended load are captured only in the captured image captured by the first wide-angle camera. As a result, the operator is prevented from feeling uncomfortable about the suspended-load hook and the suspended load captured in the overhead view image.
(4) The crane apparatus according to the present invention may further include a cabin in which an operating device is installed, and a display installed in the cabin and configured to display the overhead view image.

The overhead view image is provided to the operator who operates the crane apparatus in the cabin.
(5) The crane apparatus according to the present invention may further include a cabin in which an operating device is installed, a display installed in the cabin and configured to display the overhead view image, a derricking angle sensor configured to output a first detection value indicating a derricking angle of the boom, a boom length sensor configured to output a second detection value indicating an extension length of the boom, a slewing angle sensor configured to output a third detection value indicating a slewing position of the slewing base, and a memory. The controller is configured to further execute specified coordinates storing processing of obtaining specified coordinates in accordance with a position of a tip end portion of the boom in a real coordinate system taking the crane apparatus as a reference, based on the first detection value, the second detection value, and the third detection value, and causing the memory to store the specified coordinates, specified display position generating processing of generating position information corresponding to the specified coordinates on the overhead view image, based on the first detection value, the second detection value, the third detection value, and the specified coordinates, and display processing of causing the display to display the overhead view image in which an emphasis object is arranged at a position indicated by the position information.

The specified coordinates are coordinates indicating a special position, such as a position where the crane apparatus suspends the suspended load, a position where the crane apparatus unloads the suspended load, or a position designated by the operator, for example. When the slewing base is slewed, for example, the overhead view image is changed (rotated). Even when the overhead view image is changed, the emphasis object continues to indicate the special position. Therefore, the crane apparatus according to the present invention can cause the operator to easily recognize current status of the special position.
(6) The crane apparatus according to the present invention may further include a suspended-load hook suspended from the tip end portion of the boom by a wire rope, and a suspended-load load sensor configured to output a fourth detection value in accordance with a load applied to the wire rope. The controller is configured to execute the specified coordinates storing processing based on a fact that a suspended-load load indicated by the fourth detection value is changed.

When the suspended load is suspended or when the suspended load is unloaded, the suspended-load load is changed and the specified coordinates are stored in the memory. In other words, the specified coordinates indicate a position where the suspended load before transportation is placed or a position to where the suspended load is transported. Therefore, the crane apparatus according to the present invention can cause the operator to easily recognize the position where the suspended load before transportation is placed or the position to where the suspended load is transported in the overhead view image by the emphasis object.
(7) The crane apparatus according to the present invention may further include a suspended-load hook suspended from a tip end portion of the boom by a wire rope, a derricking angle sensor configured to output a first detection value indicating a derricking angle of the boom, a boom length sensor configured to output a second detection value indicating an extension length of the boom, and a wire sensor configured to output a fifth detection value in accordance with a distance from the tip end portion of the boom to the suspended-load hook. The controller is configured to further execute hook height calculating processing of calculating a hook height indicating a height position of the suspended-load hook based on the first detection value, the second detection value, and the fifth detection value, and hook image generating processing of generating hook image data obtained by correcting at least one of the first captured image data or the second captured image data based on the hook height, taking as a reference the suspended-load hook captured in at least one of a first captured image indicated by the first captured image data or a second captured image indicated by the second captured image data. The correction processing includes processing of correcting the first captured image data taking as a reference a predetermined position in accordance with a base end of the boom captured in the first captured image indicated by the first captured image data, and processing of correcting the second captured image data taking as a reference a predetermined position in accordance with the base end of the boom captured in the second captured image indicated by the second captured image data.

The controller may generate both of image data, the overhead view image data and the hook image data.
(8) The crane apparatus according to the present invention may further include a suspended-load hook suspended from a tip end portion of the boom by a wire rope, a derricking angle sensor configured to output a first detection value indicating a derricking angle of the boom, a boom length sensor configured to output a second detection value indicating an extension length of the boom, a suspended-load load sensor configured to output a fourth detection value in accordance with a load applied to the wire rope, and a wire sensor configured to output a fifth detection value in accordance with a distance from the tip end portion of the boom to the suspended-load hook. The controller is configured to further execute height difference calculating processing of calculating a height difference between a height position of a placement surface on which a suspended load before transportation is placed or a height position of a placement surface on which a transported suspended-load is unloaded and a crane installation surface, based on the first detection value, the second detection value, the fourth detection value, and the fifth detection value. The correction processing is executed further based on the height difference.

Since the correction processing is executed further based on the height difference between the height position of the placement surface on which the suspended load before transportation is placed or the height position of the placement surface on which the transported suspended-load is unloaded and the crane installation surface, the overhead view image having a smaller distortion can be generated.
(9) A sum of an angle of view of the first wide-angle camera and an angle of view of the second wide-angle camera may be equal to or larger than 360 degrees.

Since the sum of the angle of view of the first wide-angle camera and the angle of view of the second wide-angle camera is equal to or larger than 360 degrees, the overhead view image including entire surroundings of the crane apparatus is generated.
(10) The crane apparatus according to the present invention may further include a derricking angle sensor configured to output a first detection value indicating a derricking angle of the boom, and a memory configured to store a threshold angle. The controller is configured to execute the overhead view image generating processing based on a fact that the derricking angle indicated by the first detection value is equal to or larger than the threshold angle.

The overhead view image data is generated when the derricking angle of the boom is equal to or larger than the threshold angle. Therefore, only the overhead view image having a small distortion can be shown to the operator.
(11) The crane apparatus according to the present invention may further include a display configured to display the overhead view image, a derricking angle sensor configured to output a first detection value indicating a derricking angle of the boom, a boom length sensor configured to output a second detection value indicating an extension length of the boom, a slewing angle sensor configured to output a third detection value indicating a slewing position of the slewing base, and a memory. The controller is configured to execute specified coordinates storing processing of obtaining specified coordinates in accordance with a position of a tip end portion of the boom in a real coordinate system taking the crane apparatus as a reference, based on the first detection value, the second detection value, and the third detection value, and causing the memory to store the specified coordinates, specified display position generating processing of generating position information corresponding to the specified coordinates on the overhead view image, based on the first detection value, the second detection value, the third detection value, and the specified coordinates, specified image generating processing of generating specified image data indicating a specified image that is an image of a portion indicated by the position information out of the overhead view image, and display processing of causing the display to display the overhead view image and the specified image.

In the specified coordinates storing processing, the controller obtains the specified coordinates indicating the specified position that is a loading position or an unloading position, and causes the memory to store the coordinates. The controller generates the position information corresponding to the specified coordinates on the overhead view image, and causes the display to display the specified image that is the image of the portion of the overhead view image, the portion indicated by the position information. At the loading position or the unloading position, there is a worker who suspends or unloads cargos (suspended load). The worker may instruct the operator using body languages such as gestures, hand movements, or pointing with a finger even during slewing. When the overhead view image rotates in accordance with slewing of the slewing base, a position on the overhead view image of the worker who gives instructions to the operator is changed. Only with the overhead view image, the operator needs to search for the worker in the overhead view image. Since an image of the specified position that is the loading position or the unloading position, namely, an image of the worker is displayed on the display irrespective of the slewing of the slewing base, the operator does not need to search for the worker in the overhead view image and can surely receive the instructions of the worker.
(12) The controller may be configured to further execute generation processing of generating front extension image data indicating a front extension image including an area from a tip end of the boom to a suspended-load hook, based on the corrected first captured image data and the corrected second captured image data. The display processing includes processing of causing the display to display the front extension image.

Since the front extension image including the area from the tip end of the boom to the suspended-load hook is displayed on the display, a safety check by the operator becomes easier in a transportation work of cargos, or the like.

### Effects of the Invention

The crane apparatus according to the present invention can generate a wide-range overhead view image at a low cost.

### BRIEF DESCRIPTION OF THE DRAWINGS

FIG. 1 is a functional block of a crane apparatus 12.

FIG. 2 is a schematic side view of a crane vehicle 10 in a state where a boom 22 is caused to stand up.

FIG. 3 is a schematic side view of the crane vehicle 10 in a lie-down posture in which the boom 22 lies down.

FIG. 4 is a diagram showing an operating device 29 in a cabin 13.

FIG. 5 is a flowchart of overhead view image and the like displaying processing.

FIG. 6 (A) is a schematic diagram of a first captured image captured by a first wide-angle camera 17, FIG. 6 (B) is a schematic diagram of a second captured image captured by a second wide-angle camera 18, and FIG. 6 (C) is a schematic diagram of a synthesized overhead view image.

FIG. 7 (A) is a schematic diagram of the overhead view image during a crane work, and FIG. 7 (B) is a schematic diagram of the overhead view image in a state where a suspended load 35 is unloaded at an unloading position.

FIG. 8 is a flowchart of height difference calculating processing in a first modification example.

FIG. 9 is a flowchart of the overhead view image and the like displaying processing in the first modification example.

FIG. 10 is a schematic plan view of the crane vehicle 10 according to a second modification example.

FIG. 11 is a functional block diagram of the crane apparatus 12 according to a third modification example.

FIG. 12 is a flowchart of the overhead view image and the like displaying processing in the third modification example.

FIG. 13 is an explanatory diagram for explaining an image displayed on a display 84.

### MODES FOR CARRYING OUT THE INVENTION

Hereinafter, an embodiment of the present invention will be described. Note that it goes without saying that the embodiment described below is merely an example of the present invention, and the embodiment can be modified as appropriate without departing from the gist of the present invention. For example, an execution order of each processing described later can be changed as appropriate without departing from the gist of the present invention. Or, a part of processing described later may be omitted as appropriate without departing from the gist of the present invention.

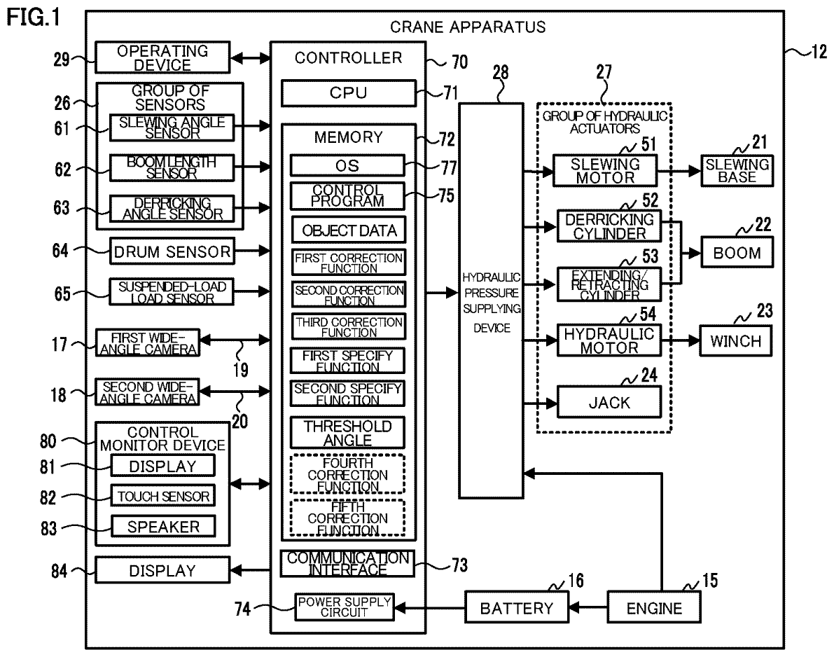

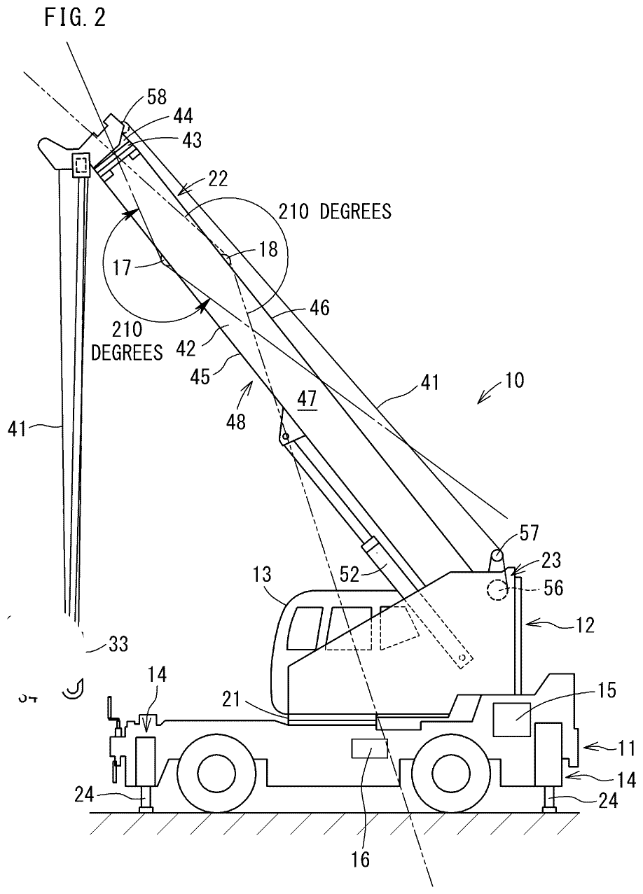

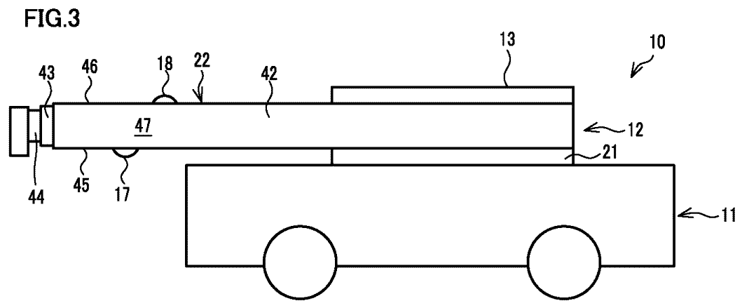

FIG. 1 is a configuration diagram and a functional block diagram of a crane apparatus 12. FIG. 2 is a side view of a crane vehicle 10 in a state where a boom 22 is caused to stand up. FIG. 3 is a schematic side view of the crane vehicle 10 in a state where the boom 22 is caused to lie down.

In the present embodiment, the crane vehicle 10 (see FIG. 2) including the crane apparatus 12 shown in FIG. 1 will be described.

As shown in FIGS. 2 and 3, the crane vehicle 10 is a rough terrain crane. However, the crane vehicle 10 may be an all terrain crane or a crawler crane.

The crane vehicle 10 includes a traveling body 11, an outrigger device 14 attached to the traveling body 11, and the crane apparatus 12 and a cabin 13 that are mounted on the traveling body 11.

The outrigger device 14 has a plurality of jacks 24 that contact with the ground to stabilize a posture of the crane vehicle 10. The crane apparatus 12 is used in a state where the jacks 24 are extended and the posture of the crane vehicle 10 is stabilized.

The crane apparatus 12 has a slewing base 21, the boom 22, a winch 23, a group of sensors 26 (see FIG. 1), a group of hydraulic actuators 27 (see FIG. 1), a hydraulic pressure supplying device 28 (see FIG. 1), an operating device 29 (see FIG. 1), a control monitor device 80 (see FIG. 1), a display 84 (see FIG. 1), a hook block 32, a first wide-angle camera 17, a second wide-angle camera 18, and a controller 70 (see FIG. 1).

The slewing base 21 is held by the traveling body 11 so as to be able to slew. A rotation axis of the slewing base 21 extends along a vertical direction (up-down direction), and is located approximately at a center of the traveling body 11.

The boom 22 is supported by the slewing base 21 so as to be able to stand and lie. In other words, the boom 22 can stand, lie, and slew.

The boom 22 includes a base boom 42, an intermediate boom 43, and a top boom 44. Each of the base boom 42, the intermediate boom 43, and the top boom 44 has a rectangular tube shape. The intermediate boom 43 is located inside the base boom 42, and the top boom 44 is located inside the intermediate boom 43. In other words, the base boom 42, the intermediate boom 43, and the top boom 44 are arranged in a nested manner, and form a so-called telescopic structure. The boom 22 extends and retracts when the intermediate boom 43 slides relative to the base boom 42 and the top boom 44 4 slides relative to the intermediate boom 43. The base boom 42, the intermediate boom 43, and the top boom 44 correspond to “tube bodies” recited in the claims. Note that the boom 22 may be configured by two tube bodies, or may be configured by four or more tube bodies.

The base boom 42 is located at an outermost. Therefore, outer surfaces of the base boom 42 are always exposed to an outside. The base boom 42 having the rectangular tube shape has four side surfaces 45, 46, 47, 48. The side surface 45 is a surface that serves as a lower surface in a lie-down posture (see FIG. 3) in which the boom 22 extends along a horizontal direction. The side surface 46 is a surface that serves as an upper surface in the lie-down posture. The side surfaces 47, 48 are surfaces that serves as a left side surface and a right side surface in the lie-down posture. The side surface 45 corresponds to “a first side surface” recited in the claims. The side surface 46 corresponds to “a second side surface” recited in the claims.

The boom 22 is supported by the slewing base 21 at the base boom 42 so as to be able to stand and lie. In other words, the base boom 42 does not move (slide) by an extension or a retraction of the boom 22. The wide-angle cameras 17, 18 are attached to the base boom 42 that does not move by the extension or the retraction of the boom 22. In other words, positions of the wide-angle cameras 17, 18 are not changed by the extension or the retraction of the boom 22.

The winch 23 is attached to a base end of the boom 22 or the slewing base 21. The winch 23 has a drum 56 around which a wire rope 41 (hereinafter denoted as “a wire 41”) is wound, and a sheave 57 around which the wire 41 is hung. The wire 41 is wound to the drum 56 or paid out from the drum 56 by driving the winch 23.

The wire 41 is hung around the sheave 57 provided at a base end portion of the boom 22, a sheave 58 provided at a tip end portion of the boom 22, and a pulley device (not shown). The pulley device has a plurality of first sheaves (not shown) provided at the tip end portion of the boom 22 and a plurality of second sheaves (not shown) provided to the hook block 32.

The hook block 32 includes a hook body 33, the plurality of second sheaves rotatably held in the hook body 33, and a hook 34 provided to a lower surface of the hook body 33. The hook block 32 or the hook 34 corresponds to “a suspended-load hook” recited in the claims.

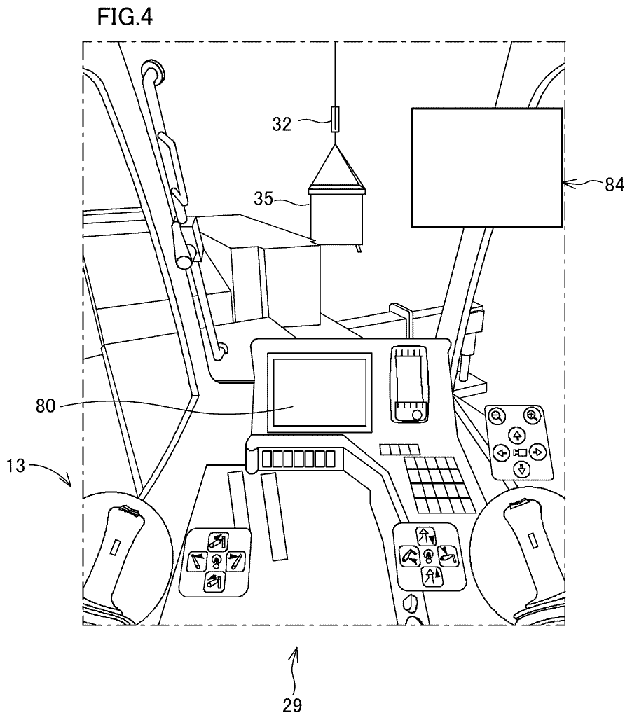

The number of times that the wire 41 is hung around the first sheaves and the second sheaves is a so-called “number of hanging wires”. As the number of hanging wires is larger, increased is a maximum suspended-load weight that is a maximum value of cargos the crane apparatus 12 can suspend. Namely, as the number of hanging wires is larger, a load-suspending capacity of the crane apparatus 12 is increased. Note that in the example shown in FIG. 2, four wires 41 are visually recognizable in a pseudo manner between the tip end portion of the boom 22 and the hook block 32, and the number of hanging wires is “4”. The number of hanging wires is input to the controller 70 through the control monitor device 80 (see FIG. 1), for example, and is stored in a memory 72 (see FIG. 1). The number of hanging wires is used to calculate a hanging down length that is a distance from the tip end portion of the boom 22 to a suspended load 35 (see FIG. 4).

Two winches 23 may be provided to the crane apparatus 12. The hook block 32 that is a so-called main hook is connected to the wire 41 of one winch 23, and a subhook (not shown) is connected to the wire 41 of the other winch 23. The hook block 32 that is the main hook and the subhook correspond to “a suspended-load hook” recited in the claims.

As shown in FIG. 1, the crane apparatus 12 includes the hydraulic pressure supplying device 28 and the group of hydraulic actuators 27. The group of hydraulic actuators 27 has a slewing motor 51, a derricking cylinder 52, an extending/retracting cylinder 53, a hydraulic motor 54, and the jacks 24.

The slewing motor 51 is a hydraulic motor that rotates via hydraulic oil supplied from the hydraulic pressure supplying device 28, and causes the slewing base 21 to slew. The derricking cylinder 52 is a hydraulic cylinder that extends and retracts via the hydraulic oil supplied from the hydraulic pressure supplying device 28, and causes the boom 22 to stand or lie. The extending/retracting cylinder 53 is a hydraulic cylinder that extends and retracts via the hydraulic oil supplied from the hydraulic pressure supplying device 28, and causes the boom 22 to extend or retract. The hydraulic motor 54 rotates via the hydraulic oil supplied from the hydraulic pressure supplying device 28, and causes the drum 56 of the winch 23 to rotate.

The hydraulic pressure supplying device 28 includes a hydraulic pump driven by an engine 15 mounted on the traveling body 11, pipes that connect the hydraulic pump with the slewing motor 51 or the like of the group of hydraulic actuators 27, and a hydraulic pressure switching valve and the like provided to the pipes and the like. The hydraulic pressure switching valve may be a so-called electromagnetic valve, and is driven by a drive signal input from the controller 70. By driving the electromagnetic valve, the slewing motor 51, the derricking cylinder 52, the extending/retracting cylinder 53, the hydraulic motor 54, and the jacks 24 are driven. Namely, the controller 70 can cause the boom 22 to slew, stand, lie, extend, and retract, wind up or pay out the wire 41, and cause the jacks 24 to extend or retract by outputting drive signals.

The group of sensors 26 has a slewing angle sensor 61, a boom length sensor 62, a derricking angle sensor 63, a drum sensor 64, and a suspended-load load sensor 65.

The slewing angle sensor 61 outputs a detection value in accordance with a slewing angle of the slewing base 21 from a slew reference position. The slew reference position is a position of a state shown in FIG. 3 in which the boom 22 protrudes forward. The slewing angle sensor 61 is a rotary encoder provided to a slewing axis of the slewing base 21, for example. The slewing angle sensor 61 outputs, as the detection value, pulse signals whose number is in accordance with the slewing angle of the slewing base 21. The detection value output by the slewing angle sensor 61 corresponds to “a third detection value” recited in the claims.

The boom length sensor 62 outputs a detection value in accordance with a length of the boom 22. The boom length sensor 62 may be a sensor that outputs the detection value indicating the length of the boom 22, may be a sensor that outputs the detection value indicating an extension length of the extending/retracting cylinder 53, or may be a sensor that outputs the detection value indicating drive time of the extending/retracting cylinder 53. The detection value output by the boom length sensor 62 corresponds to “a second detection value” recited in the claims.

The derricking angle sensor 63 outputs a detection value in accordance with a derricking angle of the boom 22. The derricking angle sensor 63 is a tilt sensor that outputs an angle with respect to a horizontal surface or a horizontal sensor, for example. Or, the derricking angle sensor 63 may be a sensor that outputs the detection value indicating an extension length or drive time of the derricking cylinder 52. The detection value output by the derricking angle sensor 63 corresponds to “a first detection value” recited in the claims.

The drum sensor 64 outputs a detection value in accordance with a payout length of the wire 41 from the winch 23. The drum sensor 64 is a rotary encoder attached to an axis of the drum 56, for example. The drum sensor 64 outputs pulse signals in accordance with paying out and winding up of the wire 41. The number of pulses per unit time indicates a rotation speed of the drum 56, namely, a payout speed or a windup speed of the wire 41, and a total number of the pulses indicates a rotation amount of the drum 56, namely, the payout length or a windup length of the wire 41. The drum sensor 64 corresponds to “a wire sensor” recited in the claims. The pulse signals output by the drum sensor 64 corresponds to “a fifth detection value” recited in the claims.

The suspended-load load sensor 65 outputs a detection value in accordance with a load applied to the wire 41 by the suspended load 35 (see FIG. 4). The suspended-load load sensor 65 is a hydraulic sensor that measures a hydraulic pressure supplied to the derricking cylinder 52, for example. The memory 72 prestores a calculation formula for calculating the load applied to the wire 41 by the suspended load 35, based on the boom length measured by the boom length sensor 62, the derricking angle measured by the derricking angle sensor 63, and the hydraulic pressure measured by the hydraulic sensor that is the suspended-load load sensor 65. Or, the memory 72 prestores a correspondence table in which the boom length measured by the boom length sensor 62, the derricking angle measured by the derricking angle sensor 63, the hydraulic pressure measured by the hydraulic sensor that is the suspended-load load sensor 65, and the load applied to the wire 41 by the suspended load 35 are associated. The load applied to the wire 41 by the suspended load 35 is calculated using the calculation formula or the correspondence table. The detection value output by the suspended-load load sensor 65 corresponds to “a fourth detection value” recited in the claims.

Note that the suspended-load load sensor 65 may be a tension meter that directly measures the load applied to the wire 41 by the suspended load 35, a load cell, or a pressure sensor that measures a hydraulic pressure supplied to the winch 23, or the like.

In the following, description will be made with also describing the detection value output by the sensor such as the slewing angle sensor 61, the boom length sensor 62, the derricking angle sensor 63, the t drum sensor 64, or the suspended-load load sensor 65 as “a sensor detection value”.

The first wide-angle camera 17 and the second wide-angle camera 18 each include a condenser lens, an optical system, a plurality of imaging elements, a control circuit, and a communication interface. The condenser lens is what is called a wide-angle lens or a fisheye lens, and the first wide-angle camera 17 and the second wide-angle camera 18 are what are called wide-angle cameras or fisheye cameras.

The optical system has a plurality of lenses and guides light collected by the condenser lens to the imaging elements, for example. The plurality of imaging elements includes image sensors such as CCDs or CMOS sensors. The plurality of imaging elements is arranged in a matrix manner (in a grid manner) . The plurality of imaging elements outputs image data in accordance with incident light. The image data consists of a plurality of pieces of pixel data and pixel position data. If a captured image is a color image, one piece of the pixel data consists of three pieces of color pixel data, for example. The control circuit captures images by the first wide-angle camera 17 and the second wide-angle camera 18 and generates the image data. The communication interface converts the image data into transmission data and outputs the converted data. The control circuit is a driver IC, for example, and the communication interface is a communication IC, for example.

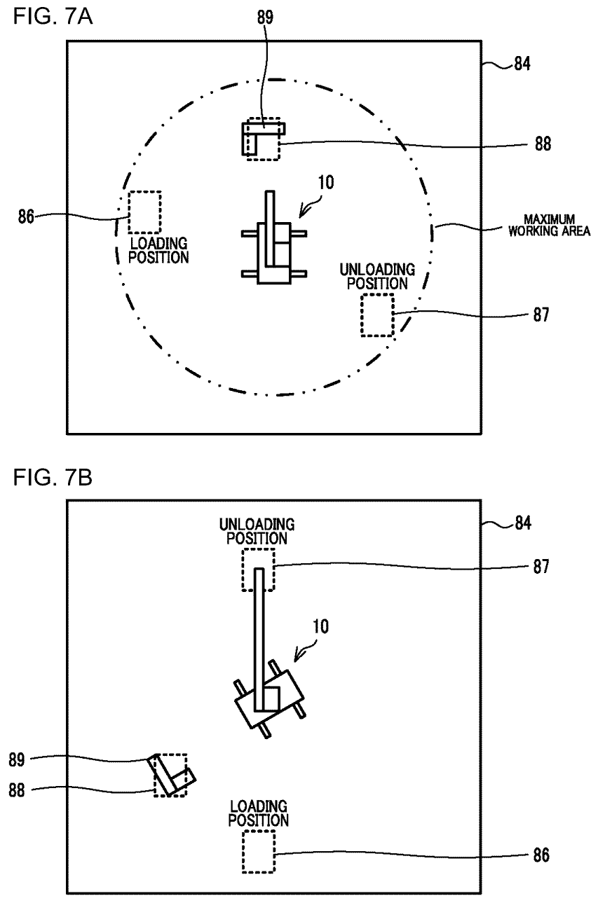

As shown in FIGS. 2 and 3, the first wide-angle camera 17 is attached to the side surface 45 of the base boom 42, and the second wide-angle camera 18 is attached to the side surface 46 of the base boom 42. The first wide-angle camera 17 and the second wide-angle camera 18 are arranged apart from a base end of the base boom 42. In other words, the first wide-angle camera 17 and the second wide-angle camera 18 are located at positions higher than the slewing base 21 in a state where the boom 22 is caused to stand up (crane working state) . Therefore, a range of an overhead view image (see FIG. 7 (A)) generated from the captured images of the first wide-angle camera 17 and the second wide-angle camera 18 becomes wider than that in a case where the cameras are attached to the slewing base 21. In other words, by attaching the first wide-angle camera 17 and the second wide-angle camera 18 to the boom 22, the overhead view image having a range wider than that in the case where the cameras are attached to the slewing base 21 can be generated.

In the example shown in FIGS. 2 and 3, the first wide-angle camera 17 and the second wide-angle camera 18 are arranged at biased positions on a tip end side of a center of the base boom 42 so as to be able to generate the overhead view image having a wider range. However, the first wide-angle camera 17 and the second wide-angle camera 18 are arranged slightly apart from the tip end of the base boom 42 so that the first wide-angle camera 17 and the second wide-angle camera 18 are appropriately apart from the wire 41.

Note that the first wide-angle camera 17 and the second wide-angle camera 18 may be arranged at a center portion of the base boom 42, or may be arranged at other biased positions on a base end side of the center of the base boom 42, as long as the range of the overhead view image that they generate covers a maximum working radius (see two-dot-dash line in FIG. 7 (A)) of the crane apparatus 12.

The first wide-angle camera 17 and the second wide-angle camera 18 may be monochrome cameras that output image data indicating monochrome images, or may be color cameras that output image data indicating color images. Furthermore, the image data output by the first wide-angle camera 17 and the second wide-angle camera 18 may be data indicating still images, or may be video data consisting of a plurality of frames.

As shown in FIG. 2, the first wide-angle camera 17 and the second wide-angle camera 18 are attached to the base boom 42 so that the first wide-angle camera 17 and the second wide-angle camera 18 are at a same height position when the derricking angle of the boom 22 is a predetermined angle, for example. In other words, the first wide-angle camera 17 and the second wide-angle camera 18 are aligned in an approximately horizontal direction in a crane work.

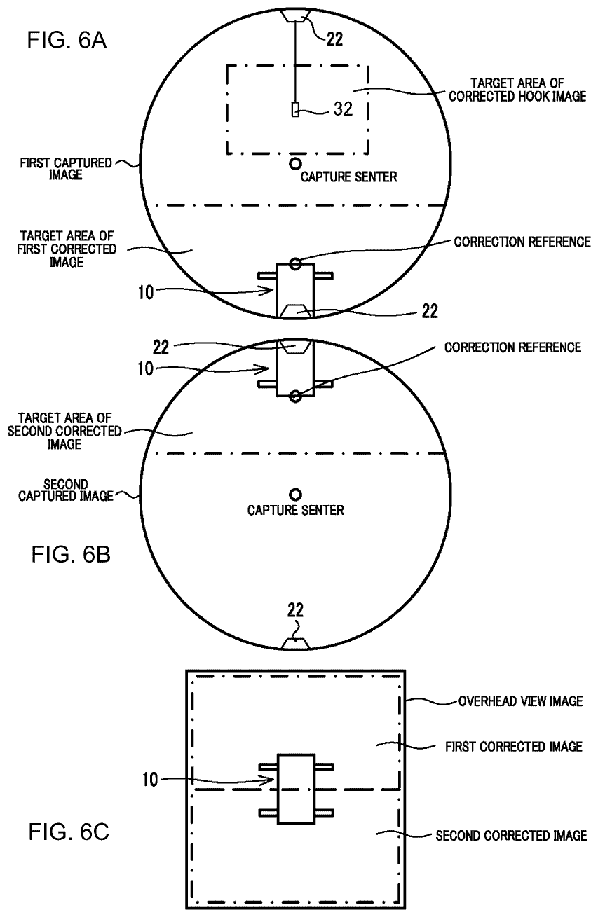

Dot-dash lines shown in FIG. 2 indicate a capture range (angle of view) of the first wide-angle camera 17, and two-dot-dash lines shown in FIG. 2 indicate a capture range (angle of view) of the second wide-angle camera 18. As shown in FIG. 2, attachment positions of the first wide-angle camera 17 and the second wide-angle camera 18 and the angles of view of the first wide-angle camera 17 and the second wide-angle camera 18 are determined so that at least a front portion of the crane vehicle 10 is within the capture range of the first wide-angle camera 17, and at least a rear portion of the crane vehicle 10 is within the capture range of the second wide-angle camera 18. In other words, the crane vehicle 10 is surely captured in the overhead view image (see FIG. 6 (C)) generated by the captured images of the first wide-angle camera 17 and the second wide-angle camera 18.

In order to be able to generate the overhead view image that captures entire surroundings of the crane vehicle 10, a sum of the angle of view of the first wide-angle camera 17 and the angle of view of the second wide-angle camera 18 is set to be equal to or larger than 360 degrees. In the example shown in FIG. 2, both of the angles of view of the first wide-angle camera 17 and the second wide-angle camera 18 are 210 degrees. In other words, the sum of the angle of view of the first wide-angle camera 17 and the angle of view of the second wide-angle camera 18 is 420 degrees. The angle of view of the first wide-angle camera 17 and the angle of view of the second wide-angle camera 18 may be different, as long as the sum of the angle of view of the first wide-angle camera 17 and the angle of view of the second wide-angle camera 18 is equal to or larger than 360 degrees. For example, the angle of view of the first wide-angle camera 17 may be 140 degrees, and the angle of view of the second wide-angle camera 18 may be 220 degrees. Note that since an angle of view of a wide-angle camera is generally 220 degrees at most, the sum of the angle of view of the first wide-angle camera 17 and the angle of view of the second wide-angle camera 18 is equal to or smaller than 440 degrees.

The slewing angle sensor 61, the boom length sensor 62, the derricking angle sensor 63, the drum sensor 64, and the suspended-load load sensor 65 included in the group of sensors 26 shown in FIG. 1 are connected to the controller 70 by cables. In other words, the sensor detection values output by the slewing angle sensor 61 and the like are input to the controller 70. Note that the sensor detection value output by each sensor may be input to the controller 70 by wireless communication.

The first wide-angle camera 17 and the controller 70 are connected by a cable 19, and the second wide-angle camera 18 and the controller 70 are connected by a cable 20. In other words, captured image data output by the first wide-angle camera 17 and the second wide-angle camera 18 is input to the controller 70 through the cables 19, 20. However, the captured image data may be input to the controller 70 by wireless communication. In this case, a battery and a sending antenna are attached to the boom 22, and a receiving antenna connected to the controller 70 by a cable is installed in the cabin 13. The first wide-angle camera 17 and the second wide-angle camera 18 capture images and send the captured image data from the sending antenna, by electric power supplied from the battery. The sent captured image data is received by the receiving antenna and is input to the controller 70.

Each sensor such as the slewing angle sensor 61 performs detections continually at a predetermined time interval (so-called sampling period/sampling cycle) and outputs the sensor detection values at the predetermined time interval. Furthermore, the first wide-angle camera 17 and the second wide-angle camera 18 capture images continually at a predetermined time interval and output the captured image data at the predetermined time interval. Or, the first wide-angle camera 17 and the second wide-angle camera 18 output the video data consisting of the plurality of frames.

FIG. 4 is a diagram showing the operating device 29 in the cabin 13.

As shown in FIG. 4, the operating device 29 is arranged in the cabin 13. The operating device 29 includes operation levers, foot pedals, operation buttons, and the like that are operated by an operator.

The operating device 29 is connected to the controller 70 by signal lines (not shown). The operator operates the operating device 29 to input instructions to the controller 70 and operates the crane apparatus 12.

As shown in FIG. 1, the control monitor device 80 includes a display 81, a transparent sheet-like touch sensor 82 overlaid on the display 81, and a speaker 83. Namely, the control monitor device 80 is a so-called AML. The operator inputs various information such as the number of hanging wires by using the touch sensor 82.

The display 84 displays the overhead view image, or the overhead view image and a hook image. The display 84 corresponds to “a display” recited in the claims.

The controller 70 includes a CPU 71 that is a central processing unit, the memory 72, a communication interface 73, a power supply circuit 74, and a communication bus (not shown). The controller 70 is realized by ICs, computers (or microcomputers), resistors, diodes, coils, capacitors, and the like implemented on a control board. The control board is arranged in a control box arranged in the cabin 13, for example. The controller 70 corresponds to “a controller” recited in the claims.

The CPU 71, the memory 72, the hydraulic pressure supplying device 28, the slewing angle sensor 61 and the like of the group of sensors 26, the wide-angle cameras 17, 18, and the operating device 29 are connected to the communication bus (not shown). A later-described control program 75 executed by the CPU 71 reads data and information from the memory 72, causes the memory 72 to store data and information, and controls driving of the group of hydraulic actuators 27. Furthermore, the control program 75 obtains the sensor detection values output by the group of sensors 26, the captured image data output by the wide-angle cameras 17, 18, and inputs made by the operator to the operating device 29.

The memory 72 prestores an OS 77 that is an operating system, and the control program 75 to be executed by the CPU 71. Furthermore, the memory 72 prestores object data, a first correction function, a second correction function, a third correction function, a first specify function, a second specify function, and a threshold angle.

The object data is data indicating emphasis objects 86, 87, 88 (see FIG. 7) to be displayed so as to overlap on the overhead view image. In the example shown in FIG. 7, shapes of the emphasis objects 86, 87, 88 are the same and are all rectangles with broken lines. However, the shape of the emphasis object 86, the shape of the emphasis object 87, and the shape of the emphasis object 88 may be different, may be other shapes such as circles, ellipses, or may be of other line types such as a solid line, a dot-dash line.

The first correction function is a function for correcting (converting) the first captured image data output by the first wide-angle camera 17 to generate first corrected image data. The second correction function is a function for correcting (converting) the second captured image data output by the second wide-angle camera 18 to generate second corrected image data. The third correction function is a function for correcting (converting) the first captured image data output by the first wide-angle camera 17 to generate hook image data.

The first specify function is a function that specifies (calculates) a position on an image of the hook block 32 captured in the first captured image captured by the first wide-angle camera 17, based on a real position of the hook block 32. The second specify function is a function that specifies (calculates) a loading position or an unloading position in the overhead view image. In other words, the second specify function is a function that obtains display positions of the emphasis objects 86, 87 to be overlapped on the overhead view image. The loading position means a place (position) where the suspended loads 35 (see FIG. 4) before being transported by the crane apparatus 12 are placed together. The unloading position means a place (position) to where the suspended loads 35 are transported by the crane apparatus 12.

The threshold angle is a minimum derricking angle of the boom 22 at which the overhead view image can be generated with a high accuracy, for example.

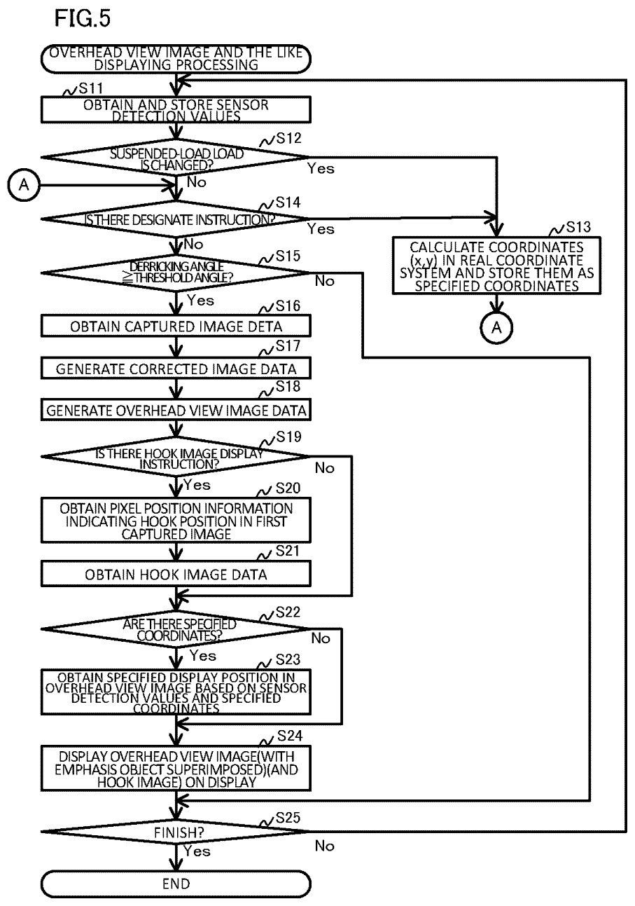

The control program 75 is a program that controls driving of the group of hydraulic actuators 27 and the like based on operation signals input from the operating device 29, and executes overhead view image and the like displaying processing described later (see FIG. 5).

The communication interface 73 is connected to the Internet 99 via a mobile communication network (not shown). The communication interface 73 converts the transmission data conforming to a communication standard of the mobile communication network into data having a format that can be input to the controller 70, or converts data output by the controller 70 into the transmission data. The communication interface 73 is a communication modem, for example.

The power supply circuit 74 converts a direct-current voltage supplied from a battery 16 mounted on the traveling body 11 into a direct-current voltage having a predetermined voltage value such as 3.3 V or 5 V, and outputs the converted voltage. The power supply circuit 74 is a DC/DC converter (power supply IC) such as a switching regulator, for example. Note that the battery 16 is charged by the engine 15 of the traveling body 11. The direct-current voltage output by the power supply circuit 74 is supplied to the CPU 71, the operating device 29, the group of sensors 26, the wide-angle cameras 17, 18, and the like. Illustrations of power supply lines from the power supply circuit 74 to the group of sensors 26 and the like are omitted in FIG. 1.

Hereinafter, processing executed by the controller 70 of the crane vehicle 10 will be described. Note that the processing executed by the controller 70 is processing that the control program 75 causes the CPU 71 to execute.

FIG. 5 is a flowchart of the overhead view image and the like displaying processing executed by the controller 70. FIG. 6 (A) is a schematic diagram of the first captured image captured by the first wide-angle camera 17. FIG. 6 (B) is a schematic diagram of the second captured image captured by the second wide-angle camera 18. FIG. 6 (C) is a schematic diagram of the overhead view image generated based on the first captured image and the second captured image. FIG. 7 (A) is a schematic diagram of the overhead view image during the crane work, and FIG. 7 (B) is a schematic diagram of the overhead view image in a state where the crane vehicle 10 unloads the suspended load 35 at the unloading position.

The overhead view image and the like displaying processing will be described with reference to FIG. 5. The controller 70 starts the overhead view image and the like displaying processing based on a fact that a power supply to the operating device 29 is turned on or based on a fact that the operator performs a predetermined input to the operating device 29 or the control monitor device 80, for example. Note that in the following, description will be made assuming that a crane installation surface (ground surface, for example) on which the crane vehicle 10 is installed and the loading position and the unloading position where the suspended load 35 is placed are at a same height position.

The controller 70 obtains the sensor detection values output by each sensor included in the group of sensors 26, and causes the memory 72 to store the values (S11). The controller 70 repeatedly obtains the sensor detection values at the predetermined sampling cycle, and causes the memory 72 to store the values.

The controller 70 determines whether a suspended-load weight is changed (increased or decreased) based on a latest sensor detection value output by the suspended-load load sensor 65 and a previous sensor detection value output by the suspended-load load sensor 65 (S12). For example, the controller 70 determines that the suspended-load weight is not changed (increased or decreased) based on a fact that an absolute value of a difference between a suspended-load load indicated by the latest sensor detection value and the suspended-load load indicated by the previous sensor detection value is smaller than a predetermined value prestored in the memory 72 (S12: No), and determines that the suspended-load load is changed (increased or decreased) based on a fact that the absolute value is equal to or larger than the predetermined value (S12: Yes). The suspended-load load is changed when the crane apparatus 12 suspends the suspended load 35 or when the crane apparatus 12 unloads the suspended load 35 (see FIG. 4). In other words, whether the suspended load 35 is suspended or whether the suspended load 35 is unloaded is determined in step S12.

When determining that the suspended-load weight is changed (S12: Yes), the controller 70 calculates coordinates (x, y) of the loading position or the unloading position in a real coordinate system as specified coordinates based on the latest sensor detection values stored in the memory 72 in step S11 and causes the memory to store the coordinates (S13). The processing of step S13 corresponds to “specified coordinates storing processing” recited in the claims.

For example, the real coordinate system is a two-dimensional coordinate system taking a slewing center of the slewing base 21 or the base end of the boom 22 (derricking center) as an origin (0, 0), taking a direction along a front-rear direction of the crane vehicle 10 as an x-axis direction, and taking a direction along a left-right direction of the crane vehicle 10 as a y-axis direction. For example, if the slewing center and a start point of derricking of the boom 22 are approximately the same, the length of the boom 22 detected by the boom length sensor 62 is L, the slewing angle detected by the slewing angle sensor 61 is α, and the derricking angle detected by the derricking angle sensor 63 is θ, x=L·cosθ·cosα and y=L·cos θ·sin α hold in the two-dimensional coordinate system (x, y).

Note that the real coordinate system may be a three-dimensional coordinate system. In other words, coordinates (x, y, z) may be calculated as the specified coordinates. In this case, z=L·sin θ+A−B holds. “A” is a value prestored in the memory 72 and indicates a height from the crane installation surface to the base end of the boom 22. “B” is a distance from the tip end portion of the boom 22 to the suspended load 35, and is a length (hanging down length) in accordance with the detection value of the drum sensor 64 and the number of hanging wires.

Furthermore, the real coordinate system may be a circular coordinate system (L, θ) or a cylindrical coordinate system (L, θ, z).

A case where the suspended-load weight is increased and a case where the suspended-load weight is decreased may be separately determined in step S12. For example, when the shape and a size of the emphasis object 86 (see FIG. 7) arranged at the position where the suspended load before transportation is placed are made different from the shape and a size of the emphasis object 87 (see FIG. 7) arranged at the position to where the suspended load 35 is transported in the overhead view image, the case where the suspended-load weight is increased and the case where the suspended-load weight is decreased are separately determined in step S12. Then, the specified coordinates indicating the loading position and the specified coordinates indicating the unloading position are separately stored in the memory 72 in step S13.

When determining that the suspended-load weight is neither increased nor decreased (S12: No), or after executing the processing of step S13, the controller 70 determines whether a designate instruction is input through the control monitor device (AML) 80 (S14). For example, if there is a place (position) that the operator wants to display in an emphasized manner in the overhead view image (see FIG. 7), the operator inputs the designate instruction when the tip end portion of the boom 22 reaches directly above the place. The place (position) that the operator wants to display in the emphasized manner is a place where an obstacle 89 (see FIG. 7) exists, for example.

When determining that the designate instruction is input (S14: Yes), the controller 70 calculates the coordinates (x, y) in the real coordinate system as the specified coordinates, based on the sensor detection values stored in the memory 72 when the designate instruction is input, and causes the memory 72 to store the specified coordinates (S13).

When determining that the designate instruction is not input (S14: No), the controller 70 determines whether the derricking angle of the boom 22 indicated by the sensor detection value obtained in step S11 is equal to or larger than the threshold angle prestored in the memory 72 (S15). Namely, whether the boom 22 is made to stand up to an angle at which the overhead view image can be generated with a high accuracy is determined in step S15. The controller 70 repeatedly executes the processing of and after step S11 until determining that the derricking angle of the boom 22 is equal to or larger than the threshold angle (S15: No, S27: No).

When determining that the derricking angle of the boom 22 is equal to or larger than the threshold angle (S15: Yes), the controller 70 obtains the first captured image data output by the first wide-angle camera 17 and the second captured image data output by the second wide-angle camera 18 (S16). The controller 70 generates the first corrected image data by correcting the first captured image data based on the obtained first captured image data, the first correction function stored in the memory 72, and the derricking angle of the boom 22 indicated by the sensor detection value obtained in step S11 (S17). Specifically, the controller 70 calls the first correction function, passes the first captured image data and the derricking angle to the first correction function as arguments, and receives the first corrected image data as a return value. Note that the first correction function may be a class that generates the first corrected image data as an instance by inputting the first captured image data and the derricking angle. The processing of step S17 corresponds to “correction processing” recited in the claims.

Generation of the first corrected image data will be described in detail with reference to FIG. 6(A). The first wide-angle camera 17 is a wide-angle camera having an angle of view of 210 degrees. Therefore, the first captured image indicated by the first captured image data captures a wide range, but has a distortion that becomes larger as apart from a capture center. The distortion depends on the angle of view of the first wide-angle camera 17 and a height of the first wide-angle camera 17 from the crane installation surface. The angle of view of the first wide-angle camera 17 is constant. The height of the first wide-angle camera 17 is determined by a distance from the base end of the base boom 42 to the first wide-angle camera 17 and the derricking angle of the boom 22. The distance from the base end of the base boom 42 to the first wide-angle camera 17 is a constant value. Therefore, the distortion of the first captured image depends on the derricking angle of the boom 22. Furthermore, an image necessary for generating the overhead view image is an image of a lower side portion of the first captured image. The first correction function is a function that corrects the distortion with respect to a predetermined range around a predetermined correction reference located on a lower side of the first captured image. The predetermined correction reference is determined to be a position in accordance with the crane vehicle 10 captured in the first captured image. More specifically, the predetermined correction reference is determined to be a position in accordance with the base end of the boom 22 in the first captured image. The position in accordance with the base end of the boom 22 includes the base end of the boom 22, the slewing center of the slewing base 21, a front end of the crane vehicle 10, a rear end of the crane vehicle 10, a center of the crane vehicle 10, or the like. The predetermined correction reference corresponds to “a predetermined position” recited in the claims.

Specifically, the first correction function performs a correction that changes positions of pixels included in the first captured image data received as the argument. The derricking angle e is used as a variable parameter in changing the pixel positions.

By the first correction function, the first captured image is corrected to a first corrected image that is an image having a viewpoint looking down the crane vehicle 10 from the first wide-angle camera 17 and having a corrected distortion.

In step S17 of the overhead view image and the like displaying processing shown in FIG. 5, the controller 70 generates the second corrected image data by correcting the second captured image data based on the second captured image data obtained in step S16, the second correction function stored in the memory 72, and the derricking angle of the boom 22 indicated by the sensor detection value obtained in step S11.

Generation of the second corrected image data will be described in detail with reference to FIG. 6 (B). The second wide-angle camera 18 is a wide-angle camera having an angle of view of 210 degrees. Therefore, the second captured image indicated by the second captured image data captures a wide range, but has a distortion that becomes larger as apart from a capture center. The distortion depends on the angle of view of the second wide-angle camera 18 and a height of the second wide-angle camera 18 from the crane installation surface. The angle of view of the second wide-angle camera 18 is constant. The height of the second wide-angle camera 18 is determined by a distance from the base end of the base boom 42 to the second wide-angle camera 18 and the derricking angle of the boom 22. The distance from the base end of the base boom 42 to the second wide-angle camera 18 is a constant value. Therefore, the distortion of the second captured image depends on the derricking angle of the boom 22. Furthermore, an image necessary for generating the overhead view image is an image of an upper side portion of the second captured image. The second correction function is a function that corrects the distortion with respect to a predetermined range around a predetermined correction reference located on an upper side of the second captured image. The predetermined correction reference is determined to be a position in accordance with the crane vehicle 10 captured in the second captured image. More specifically, the predetermined correction reference is determined to be a position in accordance with the base end of the boom 22 in the second captured image. The position in accordance with the base end of the boom 22 includes the slewing center of the slewing base 21, the front end of the crane vehicle 10, the rear end of the crane vehicle 10, the center of the crane vehicle 10, or the like. The predetermined correction reference corresponds to “a predetermined position” recited in the claims.

Specifically, the second correction function performs a correction that changes positions of pixels included in the second captured image data received as the argument. The derricking angle @ is used as a variable parameter in changing the pixel positions.

By the second correction function, the second captured image is corrected to a second corrected image that is an image having a viewpoint looking down the crane vehicle 10 from the second wide-angle camera 18 and having a corrected distortion.

In the overhead view image and the like displaying processing shown in FIG. 5, the controller 70 synthesizes the first corrected image indicated by the first corrected image data and the second corrected image indicated by the second corrected image data to generate overhead view image data indicating the overhead view image (S18). The processing of step S18 corresponds to “overhead view image generating processing” recited in the claims.

FIG. 6(C) is the overhead view image indicated by the synthesized overhead view image data. In the overhead view image, an image of the crane vehicle 10 is located at a center of the overhead view image. Surroundings of the crane vehicle 10, the surroundings having a wide range is displayed in the overhead view image. As shown in FIG. 7 (A), the overhead view image displays a range wider than the maximum working area (working radius) of the crane vehicle 10. Note that the maximum working area is shown by the two-dot-dash line in FIG. 7 (A).

In the overhead view image and the like displaying processing shown in FIG. 5, the controller 70 determines whether a hook image display instruction is input through the control monitor device (AML) 80 (S19). When the operator wants to display the hook image on the display 84 in addition to the overhead view image or in place of the overhead view image, the operator inputs the hook image display instruction through the control monitor device (AML) 80. Although not shown in the flowchart, when the hook image display instruction is input, the controller 70 causes the memory 72 to store information indicating that the hook image display instruction is input. The controller 70 determines whether the hook image display instruction is input based on whether the information is stored in the memory 72 (S19).

When determining that the hook image display instruction is input (S19: Yes), the controller 70 specifies a position of the hook block 32 (or subhook) in the first captured image (see FIG. 6 (A)) based on the sensor detection values obtained in step S11 (S20). To describe in detail, the controller 70 calculates the hanging down length that is the distance from the tip end portion of the boom 22 to the hook block 32, based on the boom length detected by the boom length sensor 62, the payout length of the wire 41 detected by the drum sensor 64, and the number of hanging wires. The hanging down length is calculated by subtracting the boom length from the payout length of the wire 41 and then dividing the difference by the number of hanging wires, for example. Furthermore, the controller 70 calculates a height of the tip end portion of the boom 22 taking the crane installation surface as a reference, based on the derricking angle detected by the derricking angle sensor 63, the boom length, and the above-described “A”. By subtracting the hanging down length from the height, the controller 70 calculates a hook height that is a height from the crane installation surface to the hook block 32. The controller 70 calls the first specify function stored in the memory 72, passes the hook height to the called first specify function as an argument, and receives pixel position information indicating a position (hook position) of the hook block 32 captured in the first captured image, as a return value. The pixel position information is a pixel number, for example. In other words, the position on the image of the hook block 32, the position serving as a center (reference) of correction for generating the hook image data from the first captured image data is specified in step S20. The processing of step S20 corresponds to “hook height calculating processing” recited in the claims.

The controller 70 obtains the hook image data based on the pixel position information indicating the correction reference, the first captured image data, and the third correction function (S21). To describe in detail, the controller 70 passes the first captured image data obtained in step S16 and the pixel position information obtained in step S20 and indicating the hook position to the third correction function as arguments, and receives corrected hook image data as a return value. The hook image indicated by the hook image data is an image that captures the hook block 32, the suspended load 35, and their periphery. A range of the periphery is a range determined by the third correction function. Note that the first specify function and the third correction function may be a single function. The processing of step S21 corresponds to “hook image generating processing” recited in the claims.

Height positions of the hook block 32 and the suspended load 35 are changed by driving of the winch 23. Therefore, positions where the hook block 32 and the suspended load 35 are captured in the first captured image are indefinite. On the other hand, in order to obtain the hook image having a corrected distortion, it is necessary to perform a correction taking the hook block 32 and the suspended load 35 in the image as correction references. Since the positions (pixel position information) of the hook block 32 and the suspended load 35 on the image are specified based on the sensor detection values, and the hook image data is generated based on the specified pixel position information, the hook image indicated by the hook image data obtained in step S21 is an image having an appropriately corrected distortion.

In this manner, the correction reference in generating the overhead view image data is the predetermined position and is fixed, and the correction reference in generating the hook image data is the hook block 32 and is variable. The overhead view image data and the hook image data having the appropriately corrected distortion are generated by appropriately setting the correction reference in generating the overhead view image data and the correction reference in generating the hook image data.

When determining in step S19 that the hook image display instruction is not input (S19: No), the controller 70 skips the processing of steps S20 and S21.

After executing the processing of step S21, or when determining in step S19 that the hook image display instruction is not input (S19: No), the controller 70 determines whether the specified coordinates are stored in the memory 72 (S22). When determining that the specified coordinates are stored in the memory 72 (S22: Yes), the controller 70 obtains a position (specified display position) corresponding to the specified coordinates in the overhead view image (see FIG. 7) based on the sensor detection values obtained in step S11 and the specified coordinates stored in the memory 72 (S23). To describe in detail, the controller 70 passes the slewing angle detected by the slewing angle sensor 61, the derricking angle of the boom 22 detected by the derricking angle sensor 63, and the specified coordinates stored in the memory 72 to the second specify function as arguments, and receives the specified display position indicating the position on the overhead view image as a return value. The specified display position is pixel position information (pixel number) £ indicating the loading position, the unloading position, or a designated position, for example. The specified display position indicates positions where the emphasis objects 86, 87, 88 (see FIG. 7) are displayed in the overhead view image. The processing of step S23 corresponds to “specified display position generating processing” recited in the claims. The specified display position corresponds to “position information corresponding to the specified coordinates on the overhead view image” recited in the claims.

After executing the processing of step S23, the controller 70 causes the display 84 to display the overhead view image on which the emphasis objects 86, 87, 88 are overlapped and the hook image (S24). Specifically, the controller 70 inputs, to the display 84, the overhead view image data generated in step S18, the hook image data obtained in step S21, and the object data to which the specified display position obtained in step S23 is added. Note that if the hook image display instruction is not input (S19: No) and the hook image data is not generated, only the overhead view image data and the object data are input to the display 84. Furthermore, if the specified coordinates are not stored in the memory 72 (S22: No) and the specified display position is not obtained, the overhead view image data without the object data is input to the display 84. The processing of step S25 corresponds to “display processing” recited in the claims.

As an example of superimposing the objects 86, 87, 88 on the overhead view image, overlapping a layer displaying the objects 86, 87, 88 on a layer displaying the overhead view image is given. In this case, the layer displaying the objects 86, 87, 88 is generated by the object data whose display position is determined by the specified display position. Furthermore, as an example of superimposing the objects 86, 87, 88 on the overhead view image, changing pixels indicated by the specified display position in pixels of the overhead view image data to the object data indicating a broken line is given.

The display 84 displays the overhead view image and the hook image. The overhead view image and the hook image are displayed side by side in up and down or in left and right. Note that the display 84 may be provided with a display changeover switch, or the control monitor device (AML) 80 may accept a display changeover instruction. In this case, the display 84 displays an image instructed by the operator using the display changeover switch or the display changeover instruction, of the overhead view image and the hook image.

Emphasis of the loading position, the unloading position, and the obstacle 89 by the emphasis objects 86, 87, 88 will be described in detail with reference to FIG. 7.

As shown in FIG. 7, when the boom 22 is slewed by the slewing base 21, the wide-angle cameras 17, 18 attached to the boom 22 also rotate, and as a result, the overhead view image also rotates. Since the display positions of the emphasis objects 86, 87, 88 in the overhead view image are calculated based on the real coordinates of the loading position, the unloading position, and the obstacle 89, the emphasis objects 86, 87, 88 do not move from the loading position, the unloading position, and the obstacle 89 in the overhead view image, even when the overhead view image rotates. If the loading position, the unloading position, and the obstacle 89 in the overhead view image were specified by image recognition, for example, processing would take time and there would be a risk of errors in the image recognition. The loading position, the unloading position, and the obstacle 89 can be surely displayed in the emphasized manner by calculating the display positions of the emphasis objects 86, 87, 88 in the overhead view image based on the real coordinates of the loading position, the unloading position, and the obstacle 89.

As shown in FIG. 5, after executing the processing of step S25, the controller 70 determines whether to finish the overhead view image and the like displaying processing (S25). The controller 70 determines to finish the processing, based on a fact that the power supply of the operating device 29 of the crane apparatus 12 is turned off or a fact that a finish instruction is input to the operating device 29 (S25: Yes), for example. When determining to finish the processing (S25: Yes), the controller 70 finishes the overhead view image and the like displaying processing (END). When determining not to finish the processing (S25: No), the controller 70 executes the processing of and after step S11 again.

### Actions and Effects of Embodiment

The first wide-angle camera 17 and the second wide-angle camera 18 are arranged facing opposite directions to each other with interposing the boom 22, and the sum of the angle of view of the first wide-angle camera 17 and the angle of view of the second wide-angle camera 18 is equal to larger than 360 degrees. Therefore, entire surroundings of the crane apparatus 12 can be captured by the two cameras. And, since the first wide-angle camera 17 and the second wide-angle camera 18 are attached to the boom 22, the cameras can capture a range wider than that in a case where cameras for generating the overhead view image are provided to the slewing base 21 or the traveling body 11. As a result, the crane apparatus 12 can generate a wide-range overhead view image at a low cost.

Since the first wide-angle camera 17 and the second wide-angle camera 18 are attached to the boom 22, the crane apparatus 12 can generate the overhead view image that covers all of its maximum working area (working radius). Namely, the loading position and the unloading position can be displayed in the overhead view image, even when the loading position and the unloading position are located at any place in the working area.

The distortion of the first captured image is corrected in the viewpoint looking down the crane vehicle 10 from the first wide-angle camera 17 by the first correction function. Furthermore, the distortion of the second captured image is corrected in the viewpoint looking down the crane vehicle 10 from the second wide-angle camera 18 by the second correction function. Therefore, the crane apparatus 12 can generate the overhead view image data indicating the overhead view image without distortion.

Since the first wide-angle camera 17 and the second wide-angle camera 18 can capture the surroundings of the crane vehicle 10 from a position higher than that in a case where the cameras are attached to the slewing base 21, the overhead view image data can be generated without performing a transformation that changes a viewpoint position, such as a projective transformation. As a result, processing load of the controller 70 is reduced.

Since the first wide-angle camera 17 and the second wide-angle camera 18 are provided to the base boom 42, wiring of the cables 19, 20 becomes easier compared to a case where the first wide-angle camera 17 and the second wide-angle camera 18 are attached to the intermediate boom 43 or the top boom 44 that is another tube body which slides relative to the base boom 42.

Since the first wide-angle camera 17 and the second wide-angle camera 18 are provided to the base boom 42, the height positions of the wide-angle cameras 17, 18 are not changed by the extension or the retraction of the boom 22. Since the height positions of the wide-angle cameras 17, 18 are not changed, a change in a height position of a viewpoint of the overhead view image by the extension and the retraction of the boom 22 can be suppressed. In other words, even when the boom 22 extends or retracts, a range captured in the overhead view image and sizes of objects, such as the suspended load 35 or the obstacle, captured in the overhead view image are not changed. As a result, an operation of the crane apparatus 12 by the operator becomes easy.

If the first wide-angle camera 17 and the second wide-angle camera 18 were respectively provided to the left and right side surfaces 47, 48 of the boom 22, there would be a possibility that the hook block 32 and the suspended load 35 attached to the hook block 32 may extend across both the captured image captured by the first wide-angle camera 17 and the captured image captured by the second wide-angle camera 18. Thus, there would be a a risk that the operator feels uncomfortable about the images of the hook block 32 and the suspended load 35 in the overhead view image generated by synthesizing the two images. By attaching the first wide-angle camera 17 to the side surface 45 of the boom 22, the hook block 32 and the suspended load 35 are only captured in the captured image captured by the first wide-angle camera 17. As a result, the operator is prevented from feeling uncomfortable about the hook block 32 and the suspended load 35 captured in the overhead view image.

Since the display positions of the emphasis objects 86, 87, 88 in the overhead view image are calculated based on the real coordinates of the loading position, the unloading position, and the obstacle 89, the loading position, the unloading position, and the obstacle 89 can be surely displayed in the emphasized manner by the emphasis objects 86, 87, 88, even when the boom 22 is slewed.

The suspended-load load is changed when the suspended load 35 is suspended or when the suspended load 35 is unloaded. The controller 70 causes the memory 72 to store the specified coordinates based on a fact that the suspended-load load is changed. Therefore, it is possible to cause the memory 72 to store the coordinates (specified coordinates) of the loading position and the unloading position. As a result, the crane apparatus 12 can cause the operator to easily recognize the loading £ position where the suspended load 35 before transportation is placed and the unloading position being a position where the transported suspended load 35 is unloaded in the overhead view image by the emphasis objects 86, 87, 88.

The position of the hook block 32 (hook position) in the first captured image is specified based on the real position of the hook block 32, and the hook image is generated based on the hook position. Therefore, it is possible to cause the display 84 of the crane apparatus 12 to display the hook image having a corrected distortion and indicating the hook block 32 and the suspended load 35 in addition to the overhead view image.

The overhead view image data is generated when the derricking angle of the boom 22 is equal to or larger than the threshold angle. Therefore, only the overhead view image having a small distortion can be shown to the operator.

### First Modification Example

In the above-described embodiment, described is a case where the height positions of the loading position and the unloading position are the same as the crane installation surface. In the present modification example, an example will be described in which there is a height difference between the height positions of the loading position and the unloading position and the crane installation surface, and the overhead view image data is generated (corrected) in accordance with the height difference. Note that configurations and processing other than those described below are the same as those described in the embodiment. The same configurations and processing as those in the embodiment are provided with the same symbols and step numbers, and descriptions thereof are omitted.

The memory 72 of the crane apparatus 12 further stores a fourth correction function and a fifth correction function shown by broken lines in FIG. 1. The fourth correction function is a function that receives the height difference as an argument in addition to the first captured image data and the derricking angle and outputs third corrected image data as a return value. The fifth correction function is a function that receives the height difference as an argument in addition to the second captured image data and the derricking angle and outputs fourth corrected image data as a return value.

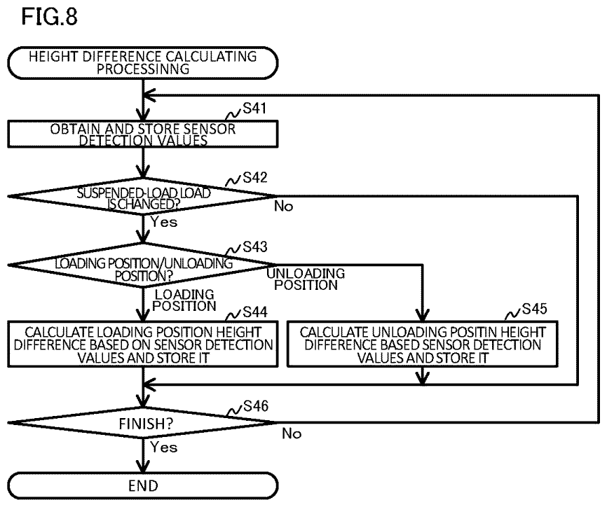

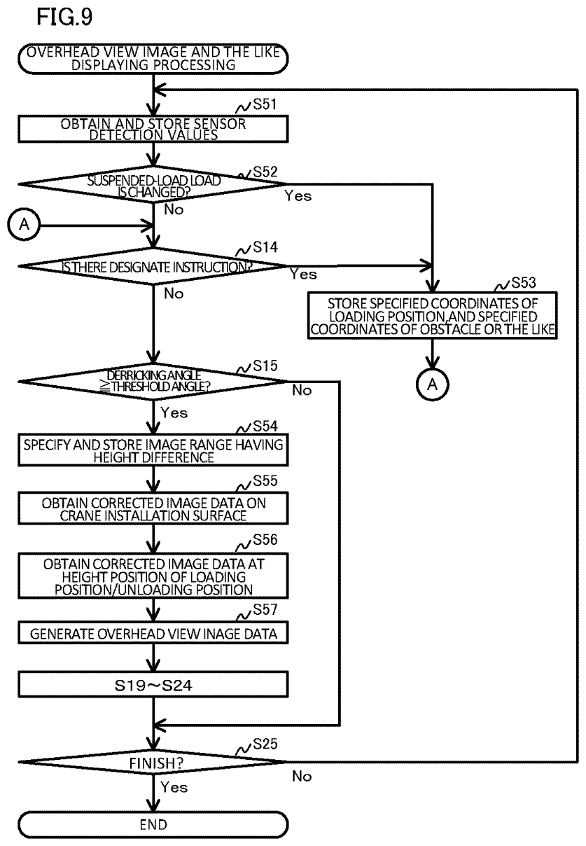

FIG. 8 is a flowchart of height difference calculating processing executed by the controller 70 of the crane apparatus 12. FIG. 9 is a flowchart of the overhead view image and the like displaying processing executed by the controller 70.

The controller 70 executes the height difference calculating processing in parallel with the overhead view image and the like displaying processing (see FIG. 9). The controller 70 repeatedly executes the height difference calculating processing at a predetermined time interval based on the fact that the power supply to the crane apparatus 12 is turned on, for example.

In the height difference calculating processing shown in FIG. 8, the controller 70 at first obtains the sensor detection values and causes the memory 72 to store the values (S41).

The controller 70 determines whether the suspended-load weight detected by the suspended-load load sensor 65 is changed (S42). Specifically, the controller 70 determines whether the suspended-load weight detected by the suspended-load load sensor 65 is changed from smaller than a first predetermined value to a second predetermined value or larger, and whether the suspended-load weight is changed from the second predetermined value or larger to smaller than the first predetermined value. The first predetermined value and the second predetermined value are prestored in the memory 72. Note that the first predetermined value and the second predetermined value may be the same.

When determining that the suspended-load weight is changed (S42: Yes), the controller 70 determines whether it is the loading position or the unloading position. Specifically, the controller 70 determines that it is the loading position based on a fact that the suspended-load weight detected by the suspended-load load sensor 65 is changed from smaller than the first predetermined value to the second predetermined value or larger (S43: loading position), and determines that it is the unloading position based on a fact that the suspended-load weight is changed from the second predetermined value or larger to smaller than the first predetermined value (S43: unloading position).

When determining that it is the loading position (S43: loading position), the controller 70 calculates a loading position height difference based on the sensor detection values stored in the memory 72 in step S41, and causes the memory 72 to store the difference (S44). Specifically, the controller 70 calculates a height H from the crane installation surface to the tip end portion of the boom 22 at a moment when the suspended load 35 is suspended, based on the boom length L detected by the boom length sensor 62 and the derricking angle θ detected by the derricking angle sensor 63, by a formula H=Lsin θ+A. The “A” is a value prestored in the memory 72 and indicates the height from the crane installation surface to the base end of the boom 22. The controller 70 calculates the loading position height difference E that is a difference between the crane installation surface and the height position (placement surface) of the loading position, by subtracting the hanging down length calculated based on the detection value of the drum sensor 64 from the height H. The height position (placement surface) of the loading position corresponds to “a placement surface on which a suspended load before transportation is placed” recited in the claims.

When determining that it is the unloading position (S43: unloading position), the controller 70 calculates an unloading position height difference F that is a difference between the crane installation surface and the height position of the unloading position, based on the sensor detection values stored in the memory 72 in step S41, and causes the memory 72 to store the difference (S45). A method for calculating the unloading position height difference F is similar to a method for calculating the loading position height difference E. The height position (placement surface) of the unloading position corresponds to “a placement surface on which a transported suspended-load is unloaded” recited in the claims.

Note that if the height position of the loading position is lower than the crane installation surface, the loading position height difference E takes a negative value. Furthermore, when the height position of the unloading position is lower than the crane installation surface, the unloading position height difference F takes a negative value.

After executing the processing of step S44 or step S45, the controller 70 determines whether to finish in a similar manner to step S27 (see FIG. 5) (S46), and executes the processing of and after step S41 based on a fact that the controller 70 determines not to finish (S46: No). The controller 70 finishes the height difference calculating processing (END) based on a fact that the controller 70 determines to finish (S46: Yes).

The controller 70 executes the overhead view image and the like displaying processing shown in FIG. 9 in place of the overhead view image and the like displaying processing shown in FIG. 5.

The controller 70 at first obtains the sensor detection values and causes the memory 72 to store the values (S51). Note that the processing of step S51 may be omitted as the processing of step S41 (see FIG. 8). Next, the controller 70 determines whether the suspended-load load detected by the suspended-load load sensor 65 is changed from smaller than the first predetermined value to the second predetermined value or larger, and whether the load is changed from the second predetermined value or larger to smaller than the first predetermined value (S52). Note that processing of step S52 may be omitted as the processing of step S42 (see FIG. 8).

When determining that the suspended-load load is changed (S52: Yes), the controller 70 calculates the specified coordinates indicating the loading position or the specified coordinates indicating the unloading position based on the sensor detection values and causes the memory 72 to store the coordinates (S53).

When determining that the suspended-load weight is not changed (S52: No), or after executing the processing of step S53, the controller 70 determines whether the designate instruction is input (S14). When determining that the designate instruction is input (S14: Yes), the controller 70 calculates the specified coordinates indicating the position of the obstacle or the like based on the sensor detection values and causes the memory 72 to store the coordinates (S53).

When determining that the designate instruction is not input (S14: No), the controller 70 determines whether the derricking angle detected by the derricking angle sensor 63 is equal to or larger than the threshold angle (S15). The controller 70 repeatedly executes the processing of and after step S51 until determining that the derricking angle of the boom 22 is equal to or larger than the threshold angle (S15: No, S27: No).

When determining that the derricking angle detected by the derricking angle sensor 63 is equal to or larger than the threshold angle (S15: Yes), the controller 70 specifies an image range having a height difference and causes the memory 72 to store the range (S54). Specifically, the controller 70 identifies a boundary line between the crane installation surface and the loading position (or unloading position) in the first captured image and the second captured image using brightness differences or lightness differences. The boundary line is data consisting of a plurality of pixel numbers, for example. Note that the image range may be prestored in the memory 72 as a predetermined range such as a circle taking the loading position or the unloading position as a center.

The controller 70 passes the first captured image data and the derricking angle to the first correction function as arguments and obtains the first corrected image data as a return value. Furthermore, the controller 70 passes the second captured image data and the derricking angle to the second correction function as arguments and obtains the second corrected image data as a return value. In other words, the controller 70 obtains corrected image data on the crane installation surface (S55).

Furthermore, the controller 70 passes the first captured image data, the derricking angle, and the height difference to the fourth correction function as arguments and obtains the third corrected image data as a return value. The third corrected image data is data obtained by correcting the first captured image data in accordance with the height of the loading position or the unloading position. Furthermore, the controller 70 passes the second captured image data, the derricking angle, and the height difference to the fifth correction function as arguments and obtains the fourth corrected image data as a return value. The fourth corrected image data is data obtained by correcting the second captured image data in accordance with the height of the loading position or the unloading position. In other words, the controller 70 obtains the corrected image data corrected in accordance with the height of the loading position or the unloading position (S56).

The controller 70 generates the overhead view image data based on the first corrected image data, the second corrected image data, the third corrected image data, the fourth corrected image data, and the image range (S57). Specifically, the overhead view image data is generated using the third corrected image data or the fourth corrected image data in a range indicated by the image range, and using the first corrected image data and the second corrected image data out of the range indicated by the image range. In other words, the overhead view image data is generated by the corrected image data corrected appropriately in accordance with the height from the crane installation surface.

The controller 70 executes the processing from step S19 to step S24 and the processing of step S25 in a manner similar to the embodiment, and finishes the overhead view image and the like displaying processing (END).

### Actions and Effects of First Modification Example

According to the present modification example, the overhead view image data in focus across the entire overhead view image and having a corrected distortion can be generated, even when the height of the loading position or the unloading position is higher or lower than the crane installation surface.

### Second Modification Example

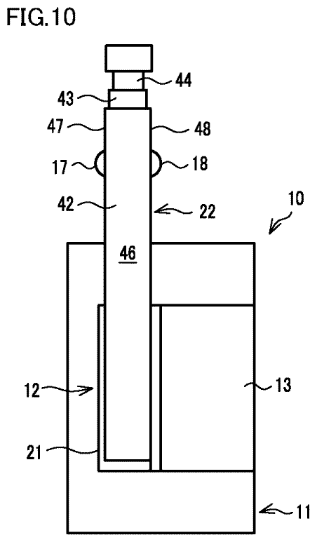

In the embodiment, described is an example in which the wide-angle cameras 17, 18 are attached to the side surfaces 45, 46 of the boom 22. In the present modification example, an example will be described in which the wide-angle cameras 17, 18 are provided to the side surfaces 47, 48 that are the left and right side surfaces of the boom 22 (see FIG. 10). Note that configurations and processing other than those described below are the same as those described in the embodiment. The same configurations and processing as those in the embodiment are provided with the same symbols and step numbers, and descriptions thereof are omitted.

FIG. 10 is a schematic plan view of the crane vehicle 10 in the state where the boom 22 is in the lie-down posture.

The first wide-angle camera 17 is attached to the side surface 47 that is the left side surface of the base boom 42. The second wide-angle camera 18 is attached to the side surface 48 that is the right side surface of the base boom 42. In other words, the two wide-angle cameras 17, 18 are respectively attached to the left and right side surfaces of the boom 22. The side surface 47 corresponds to “a first side surface” recited in the claims. The side surface 48 corresponds to “a second side surface” recited in the claims.

The first wide-angle camera 17 captures a left side of the crane vehicle 10, and the second wide-angle camera 18 captures a right side of the crane vehicle 10. In the overhead view image and the like displaying processing (see FIG. 5), the first corrected image data showing the left side of the crane vehicle 10 and the second corrected image data showing the right side of the crane vehicle 10 are synthesized to generate the overhead view image data (S18). Furthermore, the hook image data is generated and obtained based on the first captured image data and the second captured image data (S21).

### Actions and Effects of Second Modification Example

Even when the two wide-angle cameras 17, 18 are attached to the left and right side surfaces 47, 48 of the boom 22, a wide-range overhead view image data that covers the maximum working area (working radius) of the crane apparatus 12 can be generated.

### Third Modification Example

At the loading position, there is a worker who suspends the suspended load 35 on the hook block 32. Furthermore, at the unloading position, there is a worker who unloads the suspended load 35 from the hook block 32. The worker may instruct the operator using body languages such as gestures, hand movements, or pointing with a finger. In the embodiment, described is an example in which the emphasis objects 86, 87 (see FIG. 7) are arranged at the loading position and the unloading position in the overhead view image. In the present modification example, an example will be described in which an image of the specified position, such as the loading position or the unloading position, in the overhead view image (image that is a portion of the overhead view image) is displayed on the display 84 separately from the overhead view image, instead of arranging the emphasis objects 86, 87 in the overhead view image, or in addition to arranging the emphasis objects 86, 87 in the overhead view image.

Note that the position of the specified position on the overhead view image is changed by slewing of the slewing base 21. In the present modification example, instead of simply extracting a portion of the overhead view image and displaying the portion on the display 84, the specified position in the overhead view image is determined based on absolute coordinates of the specified position in the crane vehicle 10, and an image of the determined specified position is displayed on the display 84 as a specified image.

Configurations and processing other than those described below are the same as those described in the embodiment. The same configurations and processing as those in the embodiment are provided with the same symbols and step numbers, and descriptions thereof are omitted.

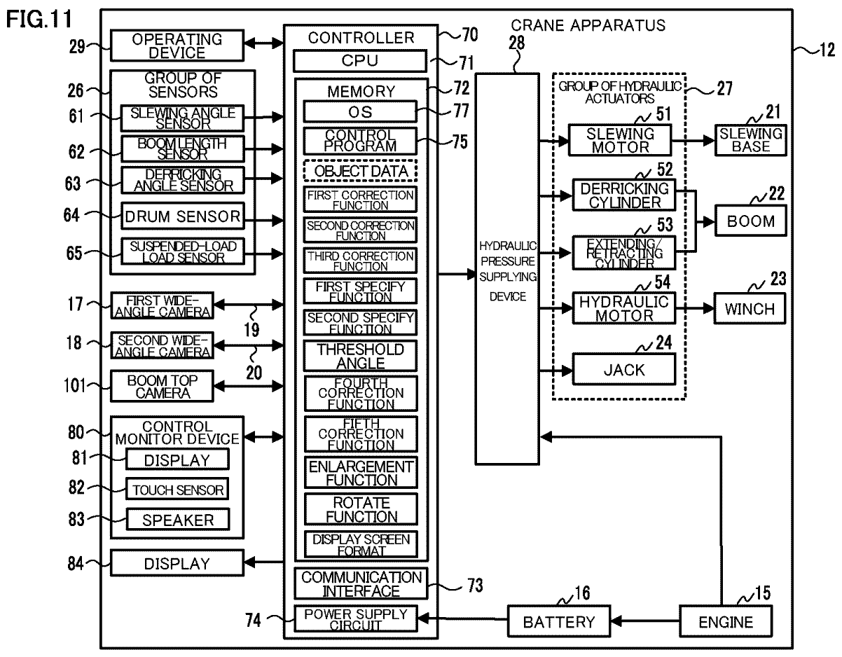

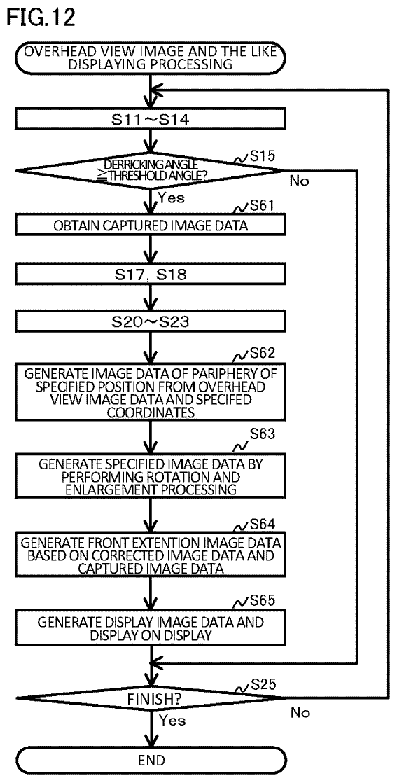

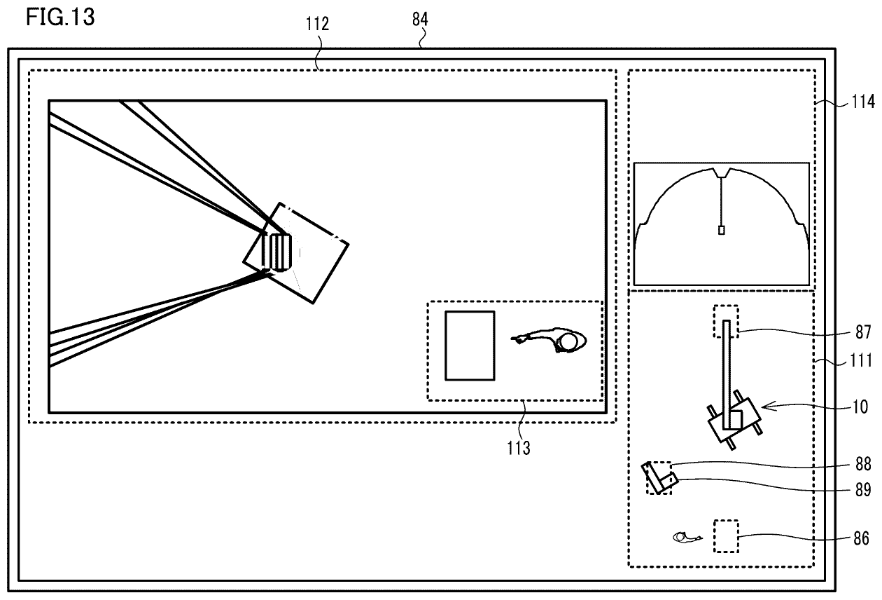

FIG. 11 is a functional block diagram of the crane apparatus 12 according to the present modification example. FIG. 12 is a flowchart of the overhead view image and the like displaying processing executed by the controller 70 (control program 75) in the present modification example. FIG. 13 is an explanatory diagram for explaining a screen displayed on the display 84 in the present modification example.

As shown in FIG. 11, the crane apparatus 12 further includes a boom top camera 101 in addition to the first wide-angle camera 17 and the second wide-angle camera 18.

The boom top camera 101 is attached to the tip end portion of the boom 22 with its lens facing downward. The boom top camera 101 generates image data indicating an image (suspended-load image) of the suspended load 35 (or hook block 32) suspended from the tip end portion of the boom 22 captured from above. The boom top camera 101 is communicably connected to the controller 70 by a cable (wired) or a radio.

The memory 72 of the controller 70 further stores an enlargement function and a rotation function for generating the specified image data, in addition to the control program 75, the correction functions, and the like. The enlargement function is a function that enlarges an image. The rotation function is a function that rotates an image. The enlargement function and the rotation function are affine transformation matrices, for example.

Furthermore, the memory 72 stores a display screen format. The display screen format is format data of a screen (see FIG. 13) displayed on the display 84. The controller 70 generates screen data to be displayed on the display 84 by inputting each image data to the display screen format.

As shown in FIG. 13, there are a first display area 111, a second display area 112, a third display area 113, and a fourth display area 114. The first display area 111 is an area where the overhead view image described in the embodiment is displayed.

The second display area 112 is an area where the suspended-load image is displayed. The suspended-load image is an image captured by the boom top camera 101.

The third display area 113 is an area where the specified image is displayed. The third display area 113 is located in the second display area 112. In other words, the specified image is displayed so as to overlap on the suspended-load image.

The fourth display area 114 is an area where a front extension image is displayed. The front extension image is an image showing an area from the tip end of the boom 22 to the hook block 32 (suspended load 35). The fourth display area 114 is located above the first display area 111 where the overhead view image is displayed. In other words, the front extension image is displayed above the overhead view image as if it were an image continuous with the overhead view image. However, the front extension image and the overhead view image may be displayed as a single image. Since the overhead view image displayed in the first display area 111 in FIG. 13 adopts a schematic diagram like FIG. 7 (B), the image does not have a sense of unity with the front extension image displayed in the fourth display area 114, however, when they are displayed as a single image, it is better to be an image obtained by combining the overhead view image (see FIG. 6 (C)) and the first captured image (see FIG. 6 (A)). Note that the area from the tip end of the boom 22 to the hook block 32 is captured by the wide-angle camera 17.

The controller 70 (control program 75) executes the overhead view image and the like displaying processing shown in FIG. 12 in place of the overhead view image and the like displaying processing shown in FIG. 5.

The controller 70 executes the processing of steps S11 to S14 in the overhead view image and the like displaying processing. In other words, the controller 70 obtains the sensor detection values and the instructions of the operator (S11), and causes the memory 72 to store the specified coordinates indicating the specified position that is the loading position, the unloading position, or the position designated by the operator (S13).

Next, the controller 70 determines whether the boom 22 is caused to stand up to an angle (threshold angle) at which the overhead view image data can be generated (S15). When determining that the boom 22 is not caused to stand up to the angle (threshold angle) at which the overhead view image data can be generated (S15: No), in other words when determining that overhead view image data cannot be generated, the controller 70 skips processing up to step S64 of generating image data such as the overhead view image data.

When determining that the boom 22 is caused to stand up to the angle (threshold angle) at which the overhead view image data can be generated (S15: Yes), the controller 70 obtains the captured image data input from the cameras 17, 18, 101 (S61).

Next, the controller 70 executes the processing of S17, S18, and S20 to S23. In other words, the controller generates the overhead view image data (S18) and the hook image data (S21), and obtains the specified display position (S23).

Next, the controller 70 generates image data indicating an image of a periphery of the specified position based on the overhead view image data obtained in step S18 and the specified display position obtained in step S23 (S62). For example, the controller 70 passes the overhead view image data and the specified display position as arguments to a specify function (not shown) prestored in the memory 72, and obtains the image data as a return value.

The controller 70 obtains the specified image data indicating the specified image based on the image data obtained in step S62, the slewing angle indicated by the sensor detection value obtained in step S11, and the rotation function and the enlargement function stored in the memory 72 (S63). Specifically, the controller 70 passes the image data obtained in step S62 and the slewing angle to the rotation function as arguments, and obtains the image data indicating the image of the periphery of the specified position and rotated in accordance with the slewing angle, as a return value. Furthermore, the controller 70 passes the image data and an enlargement ratio to the enlargement function as arguments, and obtains the specified image data as a return value.

Here, the “slewing angle” passed to the specify function is the slewing angle of the slewing base 21, taking a slewing position when the boom 22 is facing the specified position as a reference, for example. In other words, the specified image data generated in step S63 is an image facing a direction in a case where the boom 22 is facing the specified position (loading position or unloading position) irrespective of the slewing angle of the boom 22, as shown in FIG. 13.

Furthermore, the enlargement ratio passed to the specify function may be an enlargement ratio designated by the operator, or may be an enlargement ratio calculated from the derricking angle of the boom 22. For example, the controller 70 calculates a distance between the wide-angle cameras 17, 18 and the specified position from the derricking angle of the boom 22, and calculates the enlargement ratio in accordance with the distance. Note that when the wide-angle cameras 17, 18 are provided at positions whose height positions are changed in accordance with the extension length of the boom 22, such as the tip end portion of the boom 22, the enlargement ratio may be calculated further in accordance with the extension length of the boom 22.

The processing of steps S62 and S63 corresponds to “specified image generating processing” recited in the claims. The specified image generating processing (S62, S63) includes rotation processing of rotating the specified image by an angle in accordance with the third detection value indicating the slewing angle.

Next, the controller 70 generates front extension image data indicating the front extension image based on the corrected image data obtained in step S17 and the specify function (not shown) prestored in the memory 72 (S64). Specifically, the controller 70 passes the corrected image data, the image data generated by the wide-angle camera 17, and the derricking angle of the boom 22 obtained in step S11 to the specify function as arguments, and obtains the front extension image data as a return value. The processing of step S64 corresponds to “generation processing” recited in the claims.

The controller 70 generates display screen data to be displayed on the display 84 based on each of the generated image data and the display screen format stored in the memory 72 (S65). The controller 70 inputs the generated display screen data to the display 84, and causes the display 84 to display the screen (see FIG. 13) (S65). The processing of step S65 corresponds to “display processing” recited in the claims.

Note that when determined in step S15 that the boom 22 is not caused to stand up to the angle at which the overhead view image can be generated (S15: No), the processing from step S61 to S65 is skipped.

The controller 70 determines whether to finish (S25), and when determining not to finish (S25: No), the controller 70 repeatedly executes the processing of and after step S11 at a predetermined cycle of several hundred milliseconds to several seconds. When determining to finish (S25: Yes), the controller 70 finishes the overhead view image and the like displaying processing (END).

### Actions and Effects of Third Modification Example

At the loading position or the unloading position, there is a worker who suspends cargos (suspended load 35) on the hook block 32 or unloads the suspended load from the hook block 32. The worker may instruct the operator using body languages even during slewing. When the overhead view image rotates in accordance with the slewing of the boom 22 (slewing base 21), a position on the overhead view image of the worker who gives instructions to the operator is changed. Furthermore, the worker may no longer be captured in the overhead view image by the extension, the retraction, and the derricking of the boom 22, or by an enlargement of the overhead view image, or the like. Only with the overhead view image, there may be a case where the operator needs to search for the worker in the overhead view image or cannot visually recognize the worker. Since the image of the specified position that is the loading position or the unloading position is displayed on the display irrespective of the slewing of the boom 22, the operator does not need to search for the worker in the overhead view image and can surely receive the instructions of the worker. Furthermore, at the loading position and the unloading position, there may exist a worker other than the worker who gives instructions. The operator can also always check status of the worker who exists at the loading position and the unloading position.

The specified image is displayed on the display 84 after being rotated by an angle in accordance with the slewing angle of the boom 22 (slewing base 21). Therefore, a direction of the worker who exists at the specified position (loading position, unloading position) is always constant irrespective of the slewing of the boom 22. Therefore, the operator can recognize the instructions of the worker more easily, compared to a case where the direction of the worker is changed in accordance with the slewing of the boom 22.

Since the front extension image including the area from the tip end of the boom 22 to the hook block 32 is displayed on the display 84, a safety check by the operator becomes easier in a transportation work of the cargos, or the like.

In the third modification example, described is an example in which the suspended-load image is displayed in the second display area 112. However, an image of a kind designated by the operator or an image of a kind in accordance with a current work (operation) content may be displayed in the second display area 112. The current work (operation) content means a slewing operation, a winch operation, a boom derricking or extension operation, and other operations of the crane apparatus 12. The kind of the image displayed in the second display area 112 is not limited to the suspended-load image and the overhead view image, but other cameras may be installed in the crane apparatus 12 and images captured by the other cameras may be included, for example. Even when the kind of image displayed in the second display area 112 is changed, the specified image is always displayed on the display 84 (third display area 113). Since the specified image is always displayed on the display 84, the operator can always grasp status of the loading position or the unloading position no matter what operation (work) the operator is performing.

In the third modification example, described is an example in which the specified image is displayed so as to overlap on the image (suspended-load image) displayed in the second display area 112. However, the specified image may be displayed so as to overlap on other images such as the overhead view image or the front extension image, or may be displayed on the display 84 separately from other images such as the suspended-load image, the overhead view image, or the front extension image, side by side with these images.

In the third modification example, described is an example in which the overhead view image and the specified image are always displayed on the display 84. However, as for at least one of the overhead view image and the specified image, the operator may be able to select whether to display on the display 84. In other words, the overhead view image, the specified image, or both of the overhead view image and the specified image may be displayed on the display 84 only when the operator designates.

In the third modification example, described is an example in which the specified image is enlarged and displayed. However, the specified image may not necessarily be enlarged and may be displayed at the same ratio as the overhead view image.

In the third modification example, described is an example in which the specified image is rotated by the angle in accordance with the slewing angle. However, the specified image may be displayed on the display 84 without being rotated by the angle in accordance with the slewing angle.

In the third modification example, described is an example in which in step S63 the specified image is rotated by the slewing angle of the boom 22 taking as a reference the case where the boom 22 faces the specified position. However, the specified image may be rotated by the slewing angle of the boom 22 taking as a reference a case where the boom 22 faces a front of the traveling body 11 (slew reference position).

In the third modification example, described is an example in which the display 84 is installed in the cabin 13. However, the display 84 may be installed at a place other than the cabin 13. For example, the display 84 may be installed at a work site or other places in order to perform check, surveillance, supervision, or the like of the work.

In the third modification example, described is an example in which the screen of the display 84 is divided into a plurality of display areas and a plurality of images are displayed on the display 84. However, a plurality of displays may be used, and the plurality of images may be displayed by being allocated to the plurality of displays. In this case, the plurality of displays corresponds to “a display” recited in the claims.

### Other Modification Examples

In the above-described embodiment, described is an example in which the first wide-angle camera 17 and the second wide-angle camera 18 are attached to the base boom 42. However, the first wide-angle camera 17 and the second wide-angle camera 18 may be attached to the intermediate boom 43 or the top boom 44. In this case, in correcting the captured image data by the correction functions, the controller 70 passes the boom length detected by the boom length sensor 62 to the correction functions as an argument in addition to the captured image data and the derricking angle 0. In other words, the distortion of the captured image data is corrected further based on the boom length.

In the above-described embodiment, described is an example in which the specified coordinates are stored in the memory 72 based on the fact that the suspended-load load is changed (S12: Yes). However, when only the specified coordinates designated by the operator are stored in the memory 72 (S14: Yes, S13), the processing of step S12 may be not necessarily be executed. In this case, the suspended-load load sensor 65 may not necessarily be provided.

In the above-described embodiment, described is an example in which the controller 70 executes the processing of steps S12, S13, and S14 of storing the specified coordinates. However, if the emphasis objects 86, 87, 88 are not displayed in the overhead view image, the processing of steps S12, S13, and S14 may not necessarily be executed. In this case, the slewing angle sensor 61, the boom length sensor 62, the drum sensor 64, and the suspended-load load sensor 65 may not necessarily be provided.

In the above-described embodiment, described is an example in which the captured image data is corrected taking the derricking angle e detected by the derricking angle sensor 63 as the variable parameter to generate the overhead view image data. However, the captured image data may be corrected based on a predetermined correction reference (see FIG. 6) to generate the overhead view image data, without taking the derricking angle θ as the variable parameter. In this case, the derricking angle sensor 63 may not necessarily be provided.

In the above-described embodiment, described is an example in which the hook image is displayed on the display 84 by the instruction of the operator. However, the hook image may not necessarily be displayed on the display 84. In this case, the processing from step S19 to step S21 is not executed, and the hook image data is not input to the display 84 in step S25. Furthermore, the drum sensor 64 (wire sensor) may not necessarily be provided in this case.

In the above-described embodiment, described is an example in which the shape of the emphasis object 86 displayed at the loading position, the shape of the emphasis object 87 displayed at the unloading position, and the shape of the emphasis object 88 displayed at the position designated by the operator are the same in the overhead view image (see FIG. 7). However, the shape of the emphasis object 86, the shape of the emphasis object 87, and the shape of the emphasis object 88 may be different from each other. In this case, the controller 70 determines whether the suspended-load load is increased and whether the suspended-load load is decreased individually in step S12 of the overhead view image and the like displaying processing (see FIG. 5). When determining that the suspended-load load is increased, the controller 70 calculates the specified coordinates indicating the loading position from the sensor detection values and causes the memory 72 to store the coordinates, and when determining that the suspended-load load is decreased, the controller 70 calculates the specified coordinates indicating the unloading position from the sensor detection values and causes the memory 72 to store the coordinates (S13).

In the above-described embodiment, described is an example in which the position of the hook block 32 (hook position) captured in the first captured image is specified based on the sensor detection values, and the first captured image data is corrected taking the hook position as a reference to generate the hook image data. However, the hook position may be specified based on the first captured image. For example, the memory 72 prestores sample image data indicating a sample image obtained by capturing the hook block 32. The controller 70 specifies a boundary line in the first captured image based on the brightness differences and color differences, and when a shape determined by the boundary line matches or is close to a shape indicated by the sample image, the controller 70 determines that an object indicated by the shape is the hook block 32. The controller 70 determines a position where the shape determined as the hook block 32 exists as the hook position. In this case, the sensor detection values become unnecessary in generating the hook image. Namely, the controller 70 may generate the hook image from the first captured image data without using the sensor detection values.

In the above-described embodiment, described is an example in which the hook image data is generated only when there is the instruction of the operator. However, the hook image data may always be generated. In other words, the hook image may always be displayed on the display 84 of the crane apparatus 12.

In the above-described embodiment, described is an example in which the overhead view image data is not generated when the derricking angle is smaller than the threshold angle (S15: No). However, the overhead view image data may be generated even when the derricking angle is smaller than the threshold angle. In this case, the processing of step S15 is not executed.

In the above-described embodiment, described is an example in which the overhead view image data is not generated when the derricking angle is smaller than the threshold angle. However, the overhead view image data may be generated based only on the first captured image data generated by the first wide-angle camera 17 when the derricking angle is smaller than the threshold angle. To describe in detail, the first wide-angle camera 17 captures the surroundings of the crane vehicle 10 when the derricking angle is smaller than the threshold angle. Note that the second wide-angle camera 18 captures above the crane vehicle 10. The overhead view image data is generated by correcting the first captured image data of the first wide-angle camera 17 that captures the surroundings of the crane vehicle 10. Note that in this case, a center of correction is approximately a center of the first captured image. In this manner, the threshold angle may be used as a threshold for switching a method for generating the overhead view image data.

In the above-described embodiment, the first correction function and the second correction function may be functions that further perform the projective transformation to change the viewpoint in addition to the correction of the distortion. The first correction function and the second correction function may perform a viewpoint transformation that transforms to a viewpoint looking down from directly above the base end of the boom 22 or directly above the slewing center of the slewing base 21 to directly below thereof, for example. The derricking angle θ detected by the derricking angle sensor 63 is used as the variable parameter also in the viewpoint transformation. Note that after the captured image data is corrected by the first correction function or the second correction function, the image data after correction may be further transformed by a transformation function (affine transformation matrix) that performs the projective transformation.

In the above-described embodiment, described is an example in which the crane apparatus 12 is operated by the operating device 29 installed in the cabin 13. However, the crane apparatus 12 may be operated by a remote control device. In this case, the overhead view image data and the hook image data are sent to the remote control device through the Internet. The overhead view image and the hook image are displayed on a display of the remote control device.

### DESCRIPTION OF REFERENCE CHARACTERS

10: crane vehicle
11: traveling body
12: crane apparatus
13: cabin
17: first wide-angle camera
18: second wide-angle camera
19, 20: cable
21: slewing base
22: boom
23: winch
26: group of sensors
29: operating device
32: hook block
34: hook
35: suspended load
41: wire rope
42: base boom (tube body)
43: intermediate boom (tube body)
44: top boom (tube body)
45: side surface (first side surface)
46: side surface (second side surface)
47: side surface (first side surface)
48: side surface (second side surface)
51: slewing motor
52: derricking cylinder
53: extending/retracting cylinder
54: hydraulic motor
56: drum
61: slewing angle sensor
62: boom length sensor
63: derricking angle sensor
64: drum sensor
65: suspended-load load sensor
70: controller
71: CPU
72: memory
73: communication interface
75: control program
80: control monitor device
84: display
101: boom top camera

1. A crane apparatus comprising:
a slewing base;
a boom provided to the slewing base so as to be able to stand and lie, the boom being able to extend and retract;
a first wide-angle camera attached to a first side surface of the boom;
a second wide-angle camera attached to a second side surface on an opposite side of the first side surface; and
a controller configured to execute correction processing of correcting first captured image data generated by the first wide-angle camera and second captured image data generated by the second wide-angle camera, and overhead view image generating processing of generating overhead view image data indicating an overhead view image, based on corrected first captured image data and corrected second captured image data.

2. The crane apparatus according to claim 1, wherein
the boom has a plurality of tube bodies including a base boom, and
the first wide-angle camera and the second wide-angle Camera are provided to the base boom.

3. The crane apparatus according to claim 1, wherein
the first side surface is a lower surface of the boom in a lie-down posture in which the boom extends along a horizontal direction, and
the second side surface is an upper surface of the boom in the lie-down posture.

4. The crane apparatus according to claim 1, further comprising:
a cabin in which an operating device is installed; and
a display installed in the cabin and configured to display the overhead view image.

5. The crane apparatus according to claim 1, further comprising:
a cabin in which an operating device is installed;
a display installed in the cabin and configured to display the overhead view image;
a derricking angle sensor configured to output a first detection value indicating a derricking angle of the boom;
a boom length sensor configured to output a second detection value indicating an extension length of the boom;
a slewing angle sensor configured to output a third detection value indicating a slewing position of the slewing base; and
a memory, wherein
the controller is configured to further execute:
specified coordinates storing processing of obtaining specified coordinates in accordance with a position of a tip end portion of the boom in a real coordinate system taking the crane apparatus as a reference, based on the first detection value, the second detection value, and the third detection value, and causing the memory to store the specified coordinates;
specified display position generating processing of generating position information corresponding to the specified coordinates on the overhead view image, based on the first detection value, the second detection value, the third detection value, and the specified coordinates; and
display processing of causing the display to display the overhead view image in which an emphasis object is arranged at a position indicated by the position information.

6. The crane apparatus according to claim 5, further comprising:
a suspended-load hook suspended from the tip end portion of the boom by a wire rope; and
a suspended-load load sensor configured to output a fourth detection value in accordance with a load applied to the wire rope, wherein
the controller is configured to execute the specified coordinates storing processing based on a fact that a suspended-load load indicated by the fourth detection value is changed.

7. The crane apparatus according to claim 1, further comprising:
a suspended-load hook suspended from a tip end portion of the boom by a wire rope;
a derricking angle sensor configured to output a first detection value indicating a derricking angle of the boom;
a boom length sensor configured to output a second detection value indicating an extension length of the boom; and
a wire sensor configured to output a fifth detection value in accordance with a distance from the tip end portion of the boom to the suspended-load hook, wherein
the controller is configured to further execute:
hook height calculating processing of calculating a hook height indicating a height position of the suspended-load hook based on the first detection value, the second detection value, and the fifth detection value; and
hook image generating processing of generating hook image data obtained by correcting at least one of the first captured image data or the second captured image data based on the hook height, taking as a reference the suspended-load hook captured in at least one of a first captured image indicated by the first captured image data or a second captured image indicated by the second captured image data, and
the correction processing includes:
processing of correcting the first captured image data taking as a reference a predetermined position in accordance with a base end of the boom captured in the first captured image indicated by the first captured image data; and
processing of correcting the second captured image data taking as a reference a predetermined position in accordance with the base end of the boom captured in the second captured image indicated by the second captured image data.

8. The crane apparatus according to claim 1, further comprising:
a suspended-load hook suspended from a tip end portion of the boom by a wire rope;
a derricking angle sensor configured to output a first detection value indicating a derricking angle of the boom;
a boom length sensor configured to output a second detection value indicating an extension length of the boom;
a suspended-load load sensor configured to output a fourth detection value in accordance with a load applied to the wire rope; and
a wire sensor configured to output a fifth detection value in accordance with a distance from the tip end portion of the boom to the suspended-load hook, wherein
the controller is configured to further execute height difference calculating processing of calculating a height difference between a height position of a placement surface on which a suspended load before transportation is placed or a height position of a placement surface on which a transported suspended-load is unloaded and a crane installation surface, based on the first detection value, the second detection value, the fourth detection value, and the fifth detection value, and
the correction processing is executed further based on the height difference.

9. The crane apparatus according to claim 1, wherein a sum of an angle of view of the first wide-angle camera and an angle of view of the second wide-angle camera is equal to or larger than 360 degrees.

10. The crane apparatus according to claim 1, further comprising:
a derricking angle sensor configured to output a first detection value indicating a derricking angle of the boom; and
a memory configured to store a threshold angle, wherein
the controller is configured to execute the overhead view image generating processing based on a fact that the derricking angle indicated by the first detection value is equal to or larger than the threshold angle.

11. The crane apparatus according to claim 1, further comprising:
a display configured to display the overhead view image;
a derricking angle sensor configured to output a first detection value indicating a derricking angle of the boom;
a boom length sensor configured to output a second detection value indicating an extension length of the boom;
a slewing angle sensor configured to output a third detection value indicating a slewing position of the slewing base; and
a memory, wherein
the controller is configured to execute:
specified coordinates storing processing of obtaining specified coordinates in accordance with a position of a tip end portion of the boom in a real coordinate system taking the crane apparatus as a reference, based on the first detection value, the second detection value, and the third detection value, and causing the memory to store the specified coordinates;
specified display position generating processing of generating position information corresponding to the specified coordinates on the overhead view image, based on the first detection value, the second detection value, the third detection value, and the specified coordinates;
specified image generating processing of generating specified image data indicating a specified image that is an image of a portion indicated by the position information out of the overhead view image; and
display processing of causing the display to display the overhead view image and the specified image.

12. The crane apparatus according to claim 11, wherein
the controller is configured to further execute generation processing of generating front extension image data indicating a front extension image including an area from a tip end of the boom to a suspended-load hook, based on the corrected first captured image data and the corrected second captured image data, and
the display processing includes processing of causing the display to display the front extension image.
